(19) United States
(12) Patent Application Publication
(10) Pub. No.: US 2026/0323757 A1
(43) Pub. Date: Oct. 15, 2026

(54) CONNECTION MANAGEMENT FOR SMALL DATA TRANSMISSIONS AND NON-SMALL DATA TRANSMISSIONS

(71) Applicant: QUALCOMM Incorporated, San Diego, CA (US)

(72) Inventors: Shankar KRISHNAN, Poway, CA (US); Ozcan OZTURK, San Diego, CA (US); Ruiming ZHENG, Beijing (CN)

(21) Appl. No.: 19/101,285

(22) PCT Filed: Sep. 30, 2022
(86) PCT No.: PCT/CN2022/123171

§ 371 Date: Feb. 5, 2025

(51) Int. Cl. H04W 76/27; H04W 74/00; H04W 74/0833

(52) U.S. Cl. CPC H04W 76/27; H04W 74/002; H04W 74/0833

(57) ABSTRACT

A method of wireless communication performed by a first network unit includes receiving, from a user equipment (UE) in an inactive mode, an uplink (UL) small data transmission (SDT). The method further includes receiving, from a second network unit, an indication of an arrival, at the second network unit, of at least one of non-SDT downlink (DL) data or a non-SDT DL signal scheduled for the UE. The method further includes transmitting, to the UE based on the indication, a random access communication to: move the UE into a connected mode; or maintain the UE in the inactive mode.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mm Wave bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

A UE operating in a LTE-and/or NR-enabled network may operate in one of a plurality of connection modes or states to conserve power and network resources. For example, if a UE is not scheduled to receive downlink (DL) communications or to transmit uplink (UL) communications, the UE may be moved into an idle mode or an inactive mode. The network may move the UE back to a connected mode for receiving data and/or signals (e.g., reference signals) based on a request from the UE, or in response to data or signaling being scheduled for transmission to the UE. Moving the UE back into the connected mode may involve transmission of various random access and/or connection management communications between the UE and/or one or more network nodes. However, a UE in an inactive state may be permitted to transmit some relatively small and infrequent communications (e.g., data or signals) without first undergoing a state transition to the connected mode. In some aspects, the network may have performed a handover procedure prior to receiving a small data transmission (SDT) communication from the UE such that the currently-serving network node does not have contextual information for receiving and/or decoding communications from the UE.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A method of wireless communication performed by a first network unit, the method comprising: receiving, from a user equipment (UE) in an inactive mode, an uplink (UL) small data transmission (SDT); receiving, from a second network unit, an indication of an arrival, at the second network unit, of at least one of non-SDT downlink (DL) data or a non-SDT DL signal scheduled for the UE; and transmitting, to the UE based on the indication, a random access communication to: move the UE into a connected mode; or maintain the UE in the inactive mode.

A method of wireless communication performed by a first network unit, the method comprising: receiving, from a user equipment (UE) in an inactive mode, an uplink (UL) small data transmission (SDT); receiving at least one of non-SDT downlink (DL) data or a non-SDT DL signal scheduled for the UE; and in response to the receiving the at least one of the non-SDT DL data or the non-SDT DL signal, transmitting, to a second network unit: an indication of the non-SDT DL data or the non-SDT DL signal received at the first network unit; and UE context information associated with the UE.

A method of wireless communication performed by a user equipment (UE), the method comprising: transmitting, while in an inactive mode, a first random access communication to move the UE into a connected mode, wherein the first random access communication comprises at least one of uplink (UL) small data transmission (SDT) data or a UL SDT signal; receive, from a first network unit while in the inactive mode, a second random access communication to maintain the UE in the inactive mode, wherein the second random access communication comprises an indication that at least one of DL non-SDT data or DL non-SDT signal is scheduled for communication to the UE; and transmitting, based on the indication, a third random access communication to move the UE into the connected mode.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1A illustrates a wireless communication network according to some aspects of the present disclosure.

FIG. 1B illustrates an example disaggregated base station architecture according to some aspects of the present disclosure.

FIG. 2 illustrates a radio frame structure according to some aspects of the present disclosure.

FIG. 3A illustrates a method of connection management for small data transmissions and non-small data transmissions, according to some aspects of the present disclosure.

FIG. 3B illustrates a method of connection management for small data transmissions and non-small data transmissions, according to some aspects of the present disclosure.

FIG. 3C illustrates a method of connection management for small data transmissions and non-small data transmissions, according to some aspects of the present disclosure.

FIG. 3D illustrates a method of connection management for small data transmissions and non-small data transmissions, according to some aspects of the present disclosure.

FIG. 3E illustrates a method of connection management for small data transmissions and non-small data transmissions, according to some aspects of the present disclosure.

FIG. 3F illustrates a method of connection management for small data transmissions and non-small data transmissions, according to some aspects of the present disclosure.

FIG. 4 is a block diagram of a user equipment (UE) according to some aspects of the present disclosure.

FIG. 5 is a block diagram of an exemplary base station (BS) according to some aspects of the present disclosure.

FIG. 6 is a flow diagram of a communication method according to some aspects of the present disclosure.

FIG. 7 is a flow diagram of a communication method according to some aspects of the present disclosure.

FIG. 8 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ~1M nodes/km²), ultra-low complexity (e.g., ~10s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof, and (3) with enhanced mobile broadband including extreme high capacity (e.g., ~10 Tbps/km² ), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

As explained above, a UE may be configured to transition to and from a plurality of connection modes or states. In this regard, if a UE is not scheduled to receive and/or transmit communications for a period of time, the network may cause the UE to transition into an idle state or an inactive state. Moving the UE to the idle or inactive state may conserve power and network resources. When the network receives data or signals in a buffer to transmit to the UE, the network may transmit one or more paging messages to initiate a transition of the UE to a connected mode. The mechanisms for transitioning the UE to different connection modes or states may be referred to as connection management. The protocols used by the connection management mechanisms may be referred to as random access procedures or protocols. In some examples, a random access procedure may be a four-step random access procedure. For example, the UE may transmit a random access preamble and the network may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE may transmit a connection request to the BS and the BS may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE may transmit a random access preamble and a connection request in a single transmission and the BS may respond by transmitting a random access response and a connection response in a single transmission.

In some instances, the UE and/or the network may be configured to communicate some small and/or infrequent communications while the UE is in an inactive mode such that the UE may receive or transmit the communication before being transitioned into a connected mode. The permitted communications may be referred to as small data transmission (SDT) communications. SDT communications may include data and/or signals. SDT communications may include UL communications and/or DL communications. In a two-step RACH procedure, if a UL receives UL SDT data and/or a SDT UL signal in a buffer, the UE may transmit a random access communication including the SDT data and or SDT signal to a receiving BS or network node. In some aspects, the random access communication may comprise a connection request message. In some aspects, the connection request message may be or include a RRC Resume Request message. In another aspect, the random access communication may comprise a RACH preamble and the RRC Resume Request message.

In some aspects, the receiving network node may not have the UE context to receive, process, and/or forward the UL SDT transmission. For example, the UE context may be stored or otherwise available at a second network node. In some aspects, the second network node may be a last serving network node. In other aspects, the second network node may be an anchor network node. The first network node, or currently serving network node, may transmit a request for the UE context to the second network node. In some aspects, the second network node may decide not to transmit the complete UE context to the first network node that received the UL SDT communication from the UE. For example, the second network node may transmit only a portion of the UE context to the first network node. The first network node may transmit the UL SDT data and/or signal to the second network node. The second network node may forward the UL SDT data and/or signal to an access and mobility management function (AMF) node and/or a user plane function (UPF) node. In some instances, the UE and the network may perform additional UL and/or DL SDT communications while the UE is still in the inactive mode.

In some instances, the UE and/or a network node may receive non-SDT data and/or signaling in a buffer. For example, the second network node may receive DL data on a buffer of a radio bearer that is not enabled for SDT communications. In some instances, the SDT data may remain in the buffer unless and until the network and/or the UE commences a second random access procedure. For example, if the network detects that the SDT communications have completed, the UE may receive a release message with a suspend configuration indication. The network may then transmit a paging message to initiate a second random access procedure to move the UE into the connected mode.

The present disclosure describes methods, systems, and devices for connection management during SDT and non-SDT transmissions. In some aspects, a first network node receives and forwards UL SDT data and/or signals from a UE to at least one of a AMF or a UPF. In some aspects, the first network node may also communicate DL SDT data and/or signals with the UE. The first network node may receive non-SDT data and/or signals for communication to the UE. For example, the first network node may receive the non-SDT data and/or signals in a buffer. In some aspects, the buffer may be associated with a radio bearer for which SDT data is not enabled. According to an aspect of the present disclosure, the first network node may transmit, to a second network node in communication with the UE, an indication of the non-SDT data and/or signals. In some aspects, transmitting the indication may comprise transmitting a retrieve UE context response message to the second network node, where the retrieve UE context response message indicates the arrival of the non-SDT data and/or signals in the buffer. In some aspects, the retrieve UE context response message includes or indicates at least a portion of UE context. In some aspects, the second node may be referred to as a receiving node or currently-serving node. The first node may be referred to as a last-serving node or anchor node. Based on receiving the indication of the non-SDT data and/or signals, the second node may transmit a random access communication to the UE to move the UE into the connected mode. Once the UE has entered the connected mode, the UE may receive the non-SDT data and/or signals. In another aspect, the network may instead cause the UE to suspend or terminate the random access procedure in an accelerated fashion. For example, the first network node may transmit, to the second network node in response to receiving the non-SDT data and/or signal in the buffer, a release message. The second network node may forward the release message to the UE to cause the UE to remain in the inactive state or mode. In some aspects, the release message may include an indication that DL non-SDT data and/or signaling is scheduled for transmission to the UE. In some aspects, based on receiving the release message, the UE may transmit a random access message to initiate a random access procedure and move into the connected mode.

The aspects of the present disclosure provide several advantages. For example, if the network receives DL data and/or signaling for transmission to a UE during a mobile-originated SDT communication procedure, the network may expedite the state change of the UE into the connected mode so that the UE may receive the non-SDT data and/or signaling. In another aspect, releasing the UE to suspend or discontinue the random access procedure and indicating the arrival of the non-SDT data may allow for the UE to initiate a further random access procedure to receive the non-SDT data. Accordingly, latency associated with communicating non-SDT communications can be reduced, as well as power consumption. In another aspect, the UE may adjust its protocol for future SDT communications based on the indication of non-SDT data and/or signaling. For example, if the network and/or the UE experience multiple interruptions of a random-access-based SDT communication procedure by the arrival of non-SDT data and/or signaling, the UE may apply a preference for transitioning to a connected state for transmitting SDT data and/or signals. In this way, the network and/or the UE may make more adaptive decisions for connection management to handle SDT and/or non-SDT communications. Accordingly, network resources may be used more efficiently and user experience may be improved.

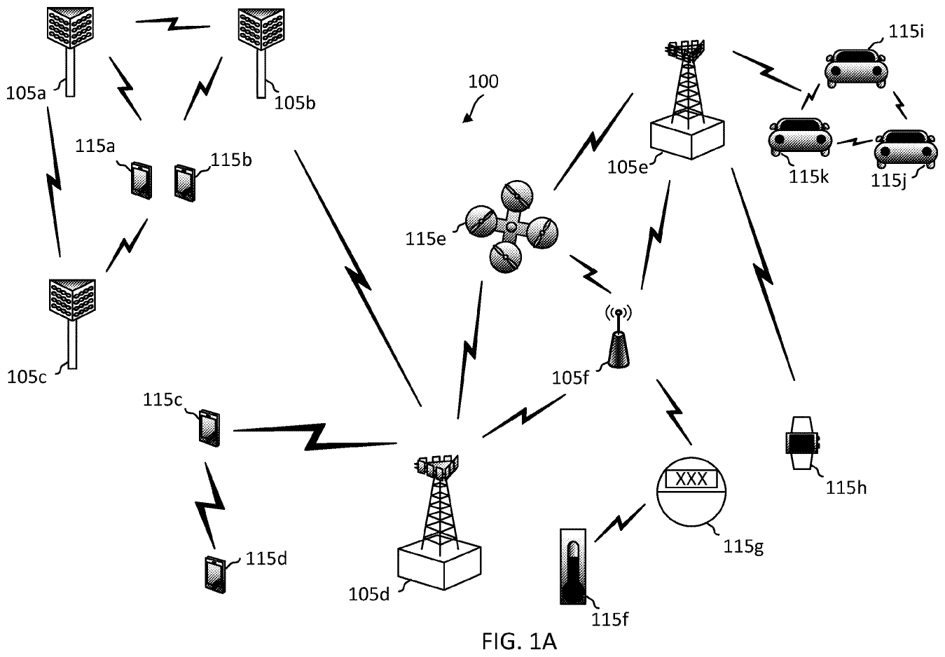

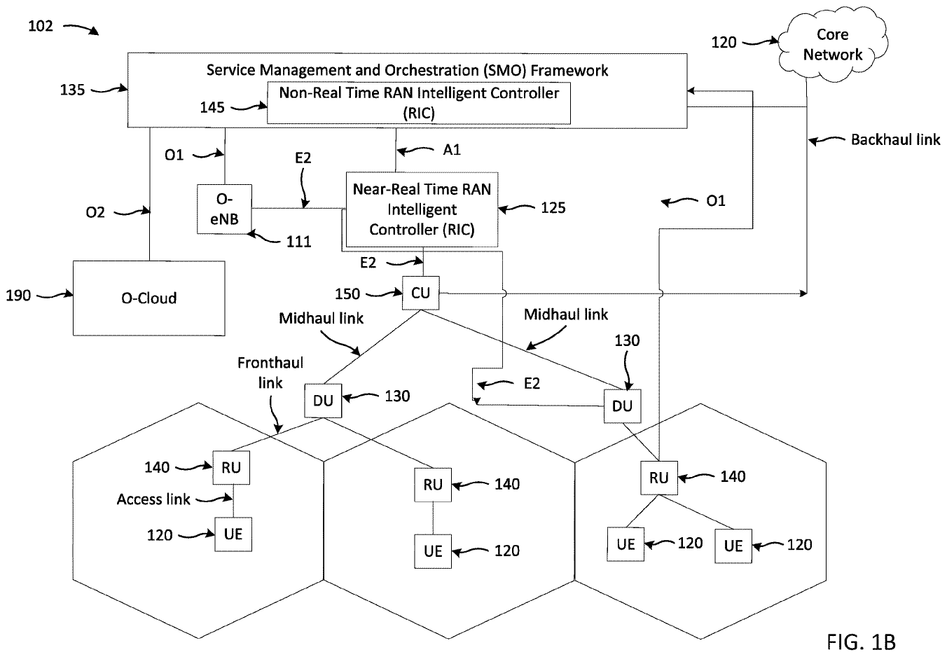

FIG. 1A illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1A, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1A, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything(V2X), cellular-V2X (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI.

After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network. The BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel.

In some aspects, the network 100 may operate over a high frequency band, for example, in a frequency range 1 (FR1) band or a frequency range 2 (FR2) band. FR1 may refer to frequencies in the sub-6 GHz range and FR2 may refer to frequencies in the mm Wave range. To overcome the high path-loss at high frequency, the BSs 105 and the UEs 115 may communicate with each other using directional beams. For instance, a BS 105 may transmit SSBs by sweeping across a set of predefined beam directions and may repeat the SSB transmissions at a certain time interval in the set of beam directions to allow a UE 115 to perform initial network access. In some instances, each beam and its corresponding characteristics may be identified by a beam index. For instance, each SSB may include an indication of a beam index corresponding to the beam used for the SSB transmission. The UE 115 may determine signal measurements, such as reference signal received power (RSRP) and/or reference signal received quality (RSRQ), for the SSBs at the different beam directions and select a best DL beam. The UE 115 may indicate the selection by transmitting a PRACH signal (e.g., MSG1) using PRACH resources associated with the selected beam direction. For instance, the SSB transmitted in a particular beam direction may indicate PRACH resources that may be used by a UE 115 to communicate with the BS 105 in that particular beam direction. After selecting the best DL beam, the UE 115 may complete the random access procedure (e.g., the 4-step random access or the 2-step random access) and proceed with network registration and normal operation data exchange with the BS 105. In some instances, the initially selected beams may not be optimal or the channel condition may change, and thus the BS 105 and the UE 115 may perform a beam refinement procedure to refine a beam selection. For instance, BS 105 may transmit CSI-RSs by sweeping narrower beams over a narrower angular range and the UE 115 may report the best DL beam to the BS 105. When the BS 105 uses a narrower beam for transmission, the BS 105 may apply a higher gain, and thus may provide a better performance (e.g., a higher signal-noise-ratio (SNR)). In some instances, the channel condition may degrade and/or the UE 115 may move out of a coverage of an initially selected beam, and thus the UE 115 may detect a beam failure condition. Upon detecting a beam failure, the UE 115 may perform a BFR with the BS 105 to request for communication over a different beam direction.

In some aspects, the network 100 may be an IoT network and the UEs 115 may be IoT nodes, such as smart printers, monitors, gaming nodes, cameras, audio-video (AV) production equipment, industrial IoT devices, and/or the like. The transmission payload data size of an IoT node typically may be relatively small, for example, in the order of tens of bytes. In some aspects, the network 100 may be a massive IoT network serving tens of thousands of nodes (e.g., UEs 115) over a high frequency band, such as a FR1 band or a FR2 band. Mechanisms for performing beamforming and beam management in a massive IoT network or any network with a massive number of nodes (e.g., UEs 115) are described in greater detail herein.

FIG. 1B shows a diagram illustrating an example disaggregated base station 102 architecture. The disaggregated base station 102 architecture may include one or more central units (CUs) 150 that can communicate directly with a core network 104 via a backhaul link, or indirectly with the core network 104 through one or more disaggregated base station units (such as a Near-Real Time (Near-RT) RAN Intelligent Controller (RIC) 125 via an E2 link, or a Non-Real Time (Non-RT) RIC 145 associated with a Service Management and Orchestration (SMO) Framework 135, or both). A CU 150 may communicate with one or more distributed units (DUs) 130 via respective midhaul links, such as an F1 interface. The DUs 130 may communicate with one or more radio units (RUs) 140 via respective fronthaul links. The RUs 140 may communicate with respective UEs 120 via one or more radio frequency (RF) access links. In some implementations, the UE 120 may be simultaneously served by multiple RUs 140.

Each of the units, i.e., the CUS 150, the DUs 130, the RUs 140, as well as the Near-RT RICs 125, the Non-RT RICs 145 and the SMO Framework 135, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 150 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 150. The CU 150 may be configured to handle user plane functionality (i.e., Central Unit-User Plane (CU-UP)), control plane functionality (i.e., Central Unit-Control Plane (CU-CP)), or a combination thereof. In some implementations, the CU 150 can be logically split into one or more CU-UP units and one or more CU-CP units. The CU-UP unit can communicate bidirectionally with the CU-CP unit via an interface, such as the El interface when implemented in an O-RAN configuration. The CU 150 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 130 may further host one or more low PHY layers. Each layer (or module) can be implemented with an interface configured to communicate signals with other layers (and modules) hosted by the DU 130, or with the control functions hosted by the CU 150.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs. In some implementations, real-time and non-real-time aspects of control and user plane communication with the RU(s) 140 can be controlled by the corresponding DU 130. In some scenarios, this configuration can enable the DU(s) 130 and the CU 150 to be implemented in a cloud-based RAN architecture, such as a vRAN architecture.

The SMO Framework 135 may be configured to support RAN deployment and provisioning of non-virtualized and virtualized network elements. For non-virtualized network elements, the SMO Framework 135 may be configured to support the deployment of dedicated physical resources for RAN coverage requirements which may be managed via an operations and maintenance interface (such as an Ol interface). For virtualized network elements, the SMO Framework 135 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 150, DUs 130, RUs 140 and Near-RT RICs 125. In some implementations, the SMO Framework 135 can communicate with a hardware aspect of a 4G RAN, such as an open eNB (O-eNB) 111, via an O1 interface. Additionally, in some implementations, the SMO Framework 135 can communicate directly with one or more RUs 140 via an O1 interface. The SMO Framework 135 also may include a Non-RT RIC 145 configured to support functionality of the SMO Framework 135.

The Non-RT RIC 145 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 145 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 150, one or more DUs 130, or both, as well as an O-eNB, with the Near-RT RIC 125.

In some implementations, to generate AI/ML models to be deployed in the Near-RT RIC 125, the Non-RT RIC 145 may receive parameters or external enrichment information from external servers. Such information may be utilized by the Near-RT RIC 125 and may be received at the SMO Framework 135 or the Non-RT RIC 145 from non-network data sources or from network functions. In some examples, the Non-RT RIC 145 or the Near-RT RIC 125 may be configured to tune RAN behavior or performance. For example, the Non-RT RIC 145 may monitor long-term trends and patterns for performance and employ AI/ML models to perform corrective actions through the SMO Framework 135 (such as reconfiguration via O1) or via creation of RAN management policies (such as A1 policies).

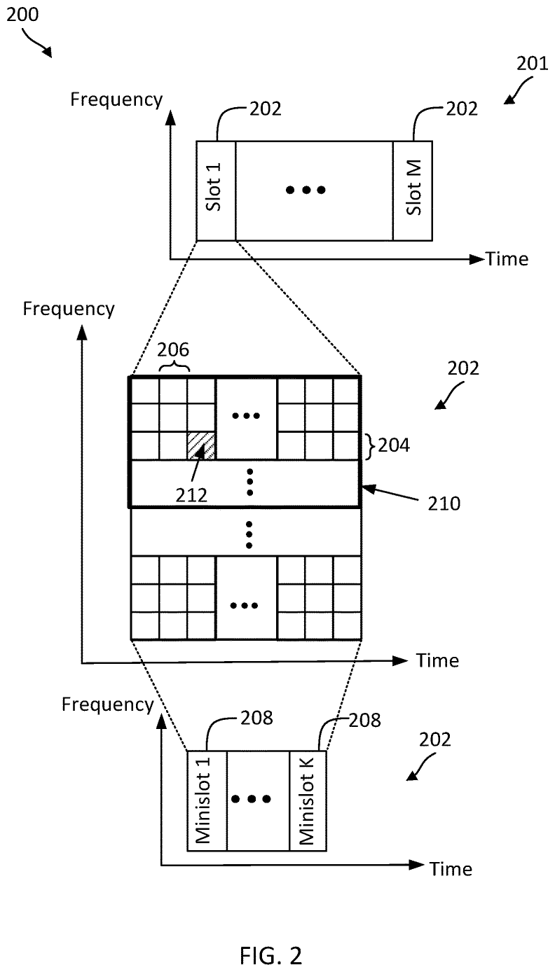

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The radio frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1A) may schedule a UE (e.g., UE 115 in FIG. 1A) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N-1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

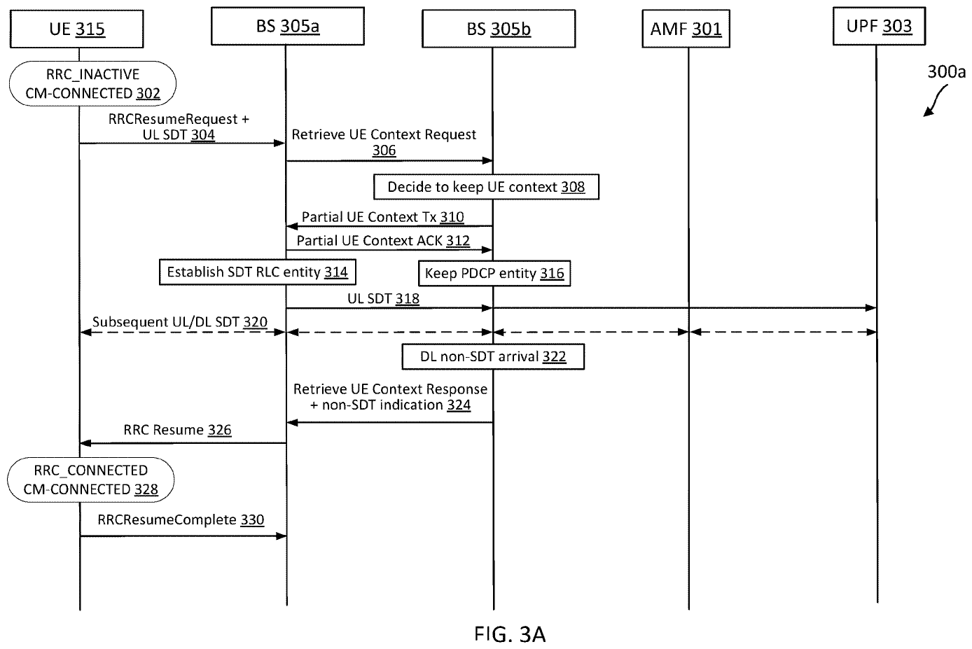

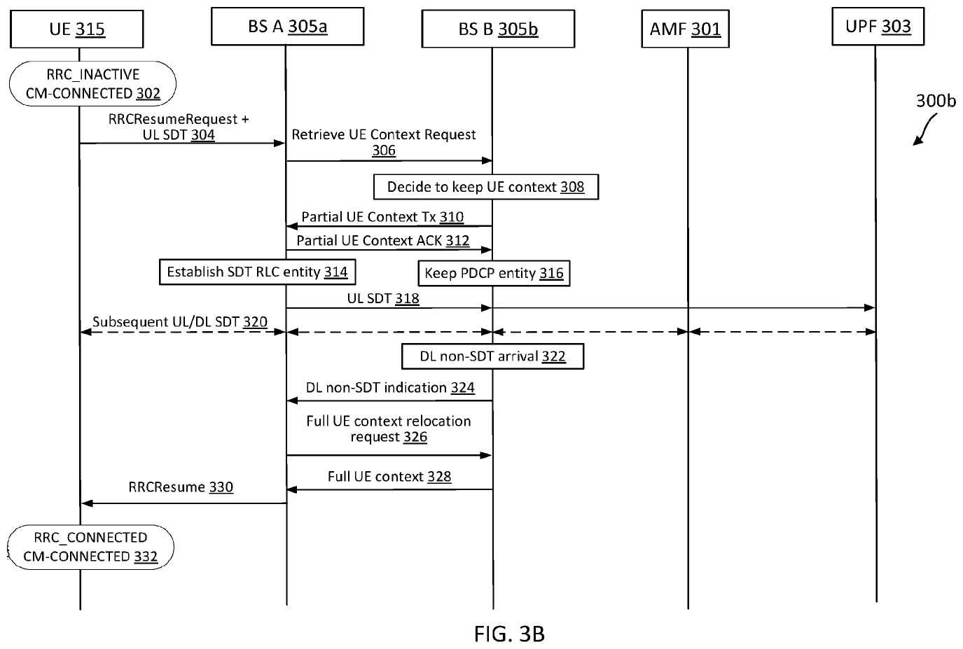

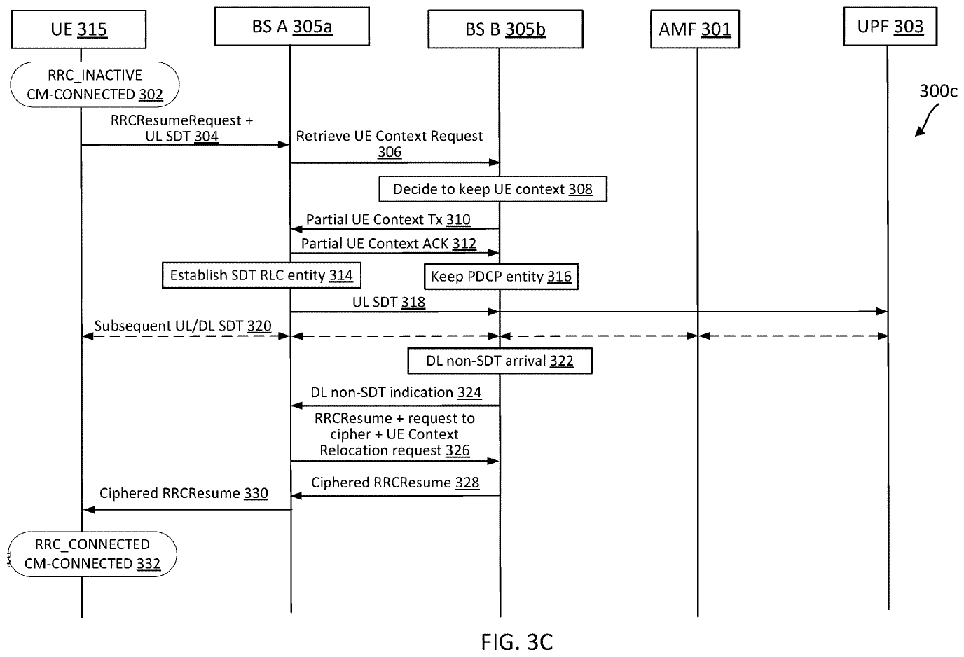

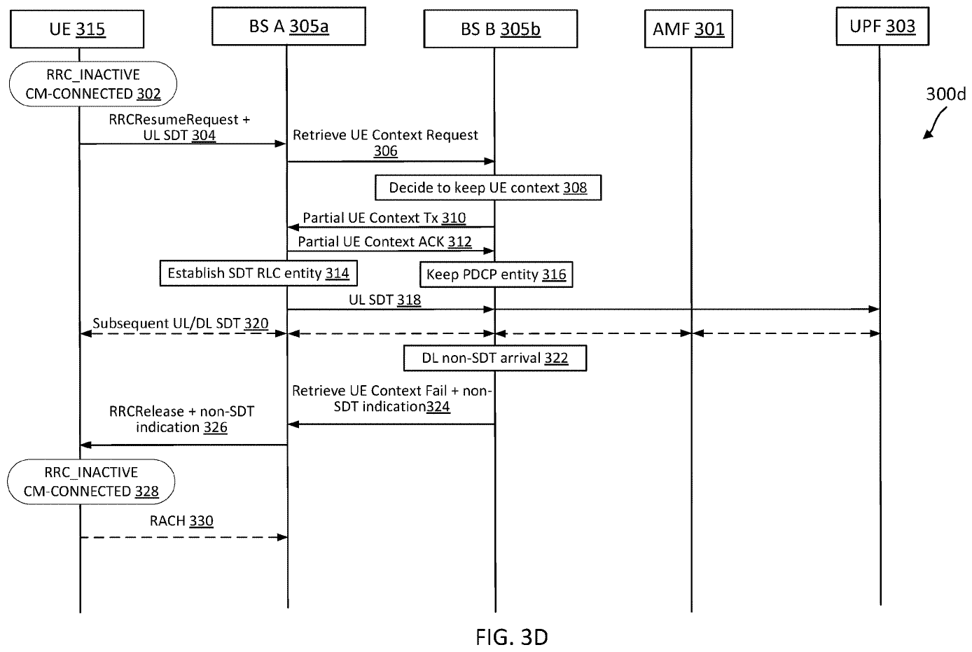

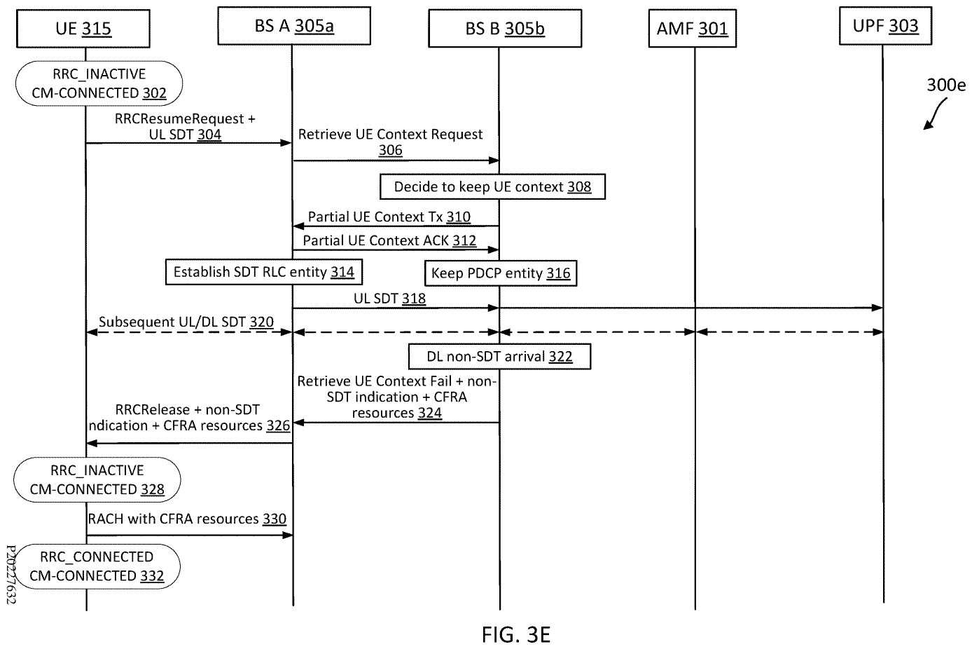

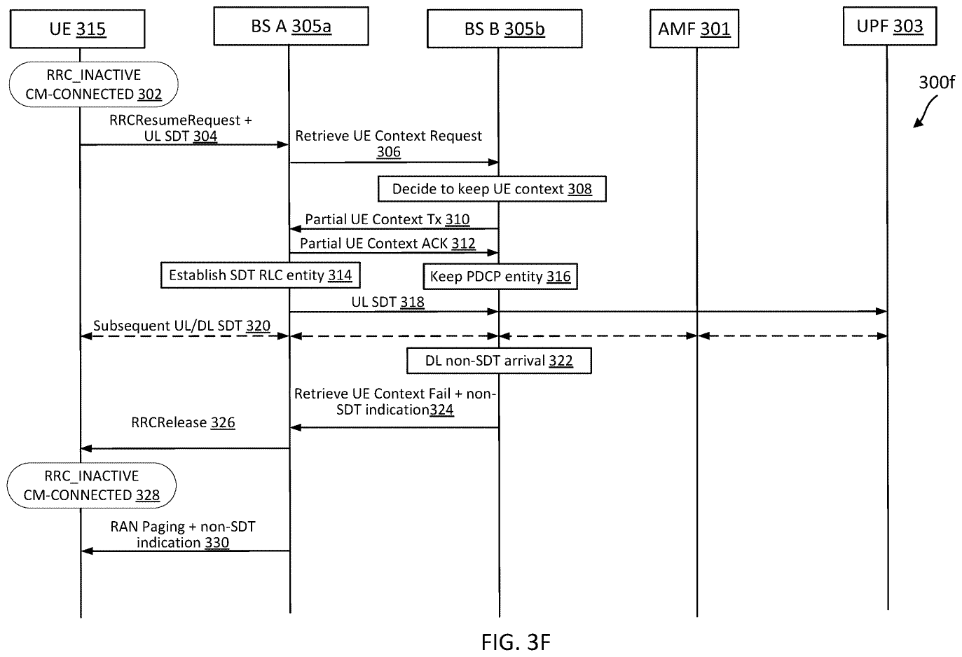

FIGS. 3A-3F are signaling diagrams illustrating various wireless communication methods 300 according to aspects of the present disclosure. The methods 300 may be performed by at least one UE 315, a first BS 305a, a second BS 305b, a AMF entity 301, and a UPF entity 303. One or both of the BSs 305a, 305b may be an aggregated BS. In another aspect, one or both of the BSs 305a, 305b may include a disaggregated BS, or a portion of a disaggregated BS. In this regard, it will be understood that the BSs 305a, 305b may be, or include network entities, units, or nodes configured to communicate with the UE 315. In some aspects, either or both of the BSs 305a, 305b may be BSs 105 of the network 100 and/or the network unit 500. In this regard, either or both of the BSs 305a, 305b may include the processor 502, memory 504, SDT module 508, transceiver 510, and/or the antennas 516. Further, the UE 315 may be one of the UEs 115 of the network 100 and/or the UE 400. In this regard, the UE 315 may comprise the processor 402, memory 404, SDT module 408, transceiver 410, and/or the antennas 416. The AMF entity 301 and the UPF entity 303 may be components or modules of the 5G core network and/or a LTE network. The AMF entity 301 and the UPF entity 303 may comprise hardware and/or software modules configured to perform their respective functions.

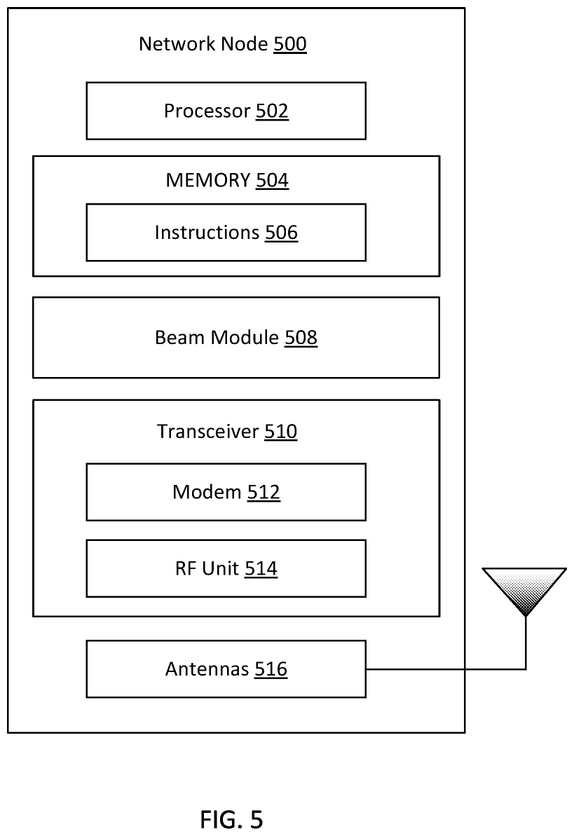

In this regard, the AMF entity 301 may include processor(s), memory, instructions, modules, and transceivers configured to store, process, configure and/or communicate flight path information in support of UE handover. The AMF entity 301 may be a controller node within the network unit 500 as shown in FIG. 5. The AMF entity 301 may be responsible for functions associated with the UE 315 including mode tracking, paging, radio bearer activation, authentication, handover, and flight plan communication. The AMF entity 301 may communicate with the BSs 305a and/or 305b using a NG interface, a S1 interface, and/or any other suitable interface. The AMF entity 301 may handle connection and handover management tasks including communicating flight plan information to the appropriate BS 305. The UPF entity 303 may provide UE IP address allocation as well as other functions. The UPF entity 303 may be connected to IP Services. The IP Services may include the Internet, an intranet, an IP Multimedia Subsystem (IMS), a PS Streaming Service, and/or other IP services.

In some aspects, the first BS 305a may be described as the receiving or currently-serving BS. The second BS 305b may be described as the previously-serving BS. In some aspects, the BSs 305a, 305b may communicate with one another using an Xn interface. As will become apparent in the foregoing disclosure, the method 300a may include mobility management procedures and actions such as UE context retrieval and/or relocation. For example, in some aspects, the UE 315 may have performed a handover procedure from the second BS 305b to the first BS 305a. However, the first BS 305a currently serving the UE 315 may not have the complete UE context of the UE 315. In some aspects, the first BS 305a may not have any of the UE context. Rather, the UE context may be located at the second BS 305b that previously served the UE 315.

According to the methods 300 shown in FIGS. 3A-3F and as will be described more fully below, the UE 315 may transmit, to at least one of the BSs 305a, 205b, a small data transmission (SDT) while in an inactive mode. For example, the UE 315 may transmit UL SDT data and/or a UL SDT signal to the first BS 205a. The first BS 305a may transmit, to the second BS 305b, an indication of the SDT communication. The second BS 305b may be referred to as the anchor BS, previously-serving BS, or last serving BS. The SDT transmission may be communicated with a random access communication, such as a RRC Resume Request. Transmitting the SDT communication may include transmitting a MSG1 of a two-part or four-part RACH procedure. As explained above, the first BS 305a may not have the complete UE context to receive and/or forward the SDT communication to the correct network node (e.g., AMF 301, UPF 303, etc.). Further, the second BS 305b may receive DL non-SDT data and/or DL non-SDT signaling for transmission to the UE 315. For example, the second BS 305b may receive the DL non-SDT data and/or the DL non-SDT signaling in a buffer of a radio bearer that is not enabled for SDT communication. The first BS 305a, which is configured as the currently-serving or receiving BS for the UE 315, may not be aware of the arrival of the DL non-SDT data and/or signaling. According to aspects of the present disclosure, the second BS 305b may transmit, to the first BS 305a, an indication of the arrival of the non-SDT data and/or signaling. In some aspects, the indication may cause the first BS 305a to complete the random access procedure initiated with the transmission of the UL SDT data and/or signaling to move the UE 315 into a connected mode for receiving non-SDT data and/or signaling from the second BS 305b via the first BS 305a. In other aspects, the indication may cause the first BS 305a to transmit a random access suspension indication to maintain the UE 315 in the inactive mode and prepare the UE 315 perform an additional random access procedure to receive the non-SDT communication.

Referring to the method 300a shown in FIG. 3A, at action 302, the UE 315 is in an inactive mode or state. For example, the UE 315 may be in a radio resource control (RRC) inactive state (RRC_INACTIVE) and in a connection management connected state (CM-CONNECTED). In other aspects, the UE 315 may be in an idle mode at action 302, such as RRC_IDLE. In the inactive mode, the UE 315 may perform limited or reduced signaling and/or monitoring to reduce power consumption. In some aspects, the UE 315 may transition to the inactive mode in response to receiving a release and/or suspend message while in a connected mode.

At action 304, the UE 315 transmits, and the first BS 305a receives, a random access communication including uplink (UL) SDT data and/or signaling. In some aspects, the random access communication comprises a connection request or resume connection request. In some aspects, the message includes a RRCResumeRequest message. In some aspects, the random access communication comprises a RACH preamble. In other aspects, the random access communication comprises a combination of a RRCResumeRequest message and a RACH preamble. The UL SDT data and/or signaling may be included with the random access communication in a single message or transmission. For example, the UE 315 may transmit the RRCResumeRequest message and the UL SDT data and/or signaling in a same physical uplink shared channel (PUSCH) transmission. In other aspects, the random access communication and the UL SDT data and/or signaling may be carried in separate messages or communications.

At action 306, the first BS 305a transmits, to the second BS 305b in response to receiving the random access communication and UL SDT data and/or signaling at action 304, a request to retrieve UE context. In some aspects, transmitting the request may comprise transmitting a RETREIVE UE CONTEXT REQUEST message. In some aspects, the message may include an SDT indicator indicating the arrival of the UL SDT data and/or signaling. The message may further include UE assistance information. The UE assistance information may be based on the communication received by the first BS 305a at action 304. In some aspects, the request to retrieve the UE context may comprise a Xn message.

At action 308, the second BS 305b determines or decides to keep at least a portion of the UE context. In this regard, the second BS 305b may determine not to transfer the complete UE context to the first BS 305a. For example, the second BS 305b may determine to transmit a portion of the UE context. For example, the second BS 305b may determine to transfer a first portion of the UE context so that the first BS 305a may establish a SDT radio bearer, such as a data radio bearer (DRB) or a signaling radio bearer (SRB). The second BS 305b may retain a portion of the UE context to establish a packet data convergence protocol (PDCP) entity.

At action 310, the second BS 305b transmits, and the first BS 305a receives, a partial UE context transfer. The partial UE context transfer may include UE identifiers, UE capability information, configuration parameters, subscription information, security information, and/or other information associated with the UE to enable the first BS 305a to receive, decode, and/or transfer the SDT data and/or signaling. In some aspects, the partial UE context transfer may be transmitted using a Xn message.

At action 312, the first BS 305a transmits, to the second BS 305b, a partial UE context transfer acknowledge message. In some aspects, the partial UE context transfer acknowledge message may comprise a Xn message. In some aspects, the partial UE context transfer acknowledge message may indicate that the partial UE context was received by the first BS 305a.

At action 314, the first BS 305a establishes, based on the partial UE context transfer, a SDT RLC entity. In some aspects, the SDT RLC entity is based on the partial UE context received from the second BS 305b. In some aspects, the SDT RLC entity may enable the first BS 305a to receive, forward, decode, and/or otherwise handle SDT data and/or signaling to and from the UE 315.

At action 316, the second BS 305b establishes or retains a PDCP entity based on the portion of the UE context retained by the second BS 305b. In some aspects, the PDCP entity may enable the second BS 305b to receive, decode, forward, and/or otherwise handle non-SDT communications to and from the UE 315.

At action 318, the first BS 305a transmits the UL SDT data and/or signaling received at action 304 to the second BS 305b. In some aspects, transmitting the UL SDT communication may comprise the first BS 305a transmitting the UL SDT communication to the second BS 305b in a Xn message. The second BS 305b forwards or transfers the UL SDT communication to the UPF 303. In some aspects, the transfer of the SDT communication to the UPF 303 may be based on a NG interface. For example, the second BS 305b may forward the UL SDT communication to the UPF 303 in a NG-U message. In another aspect, the second BS 305b may forward the UL SDT communication to the AMF 301 in a NG-C message.

At action 320, the UE 315, first BS 305a, second BS 305b, the AMF 301, and/or the UPF 303 perform additional UL and/or DL SDT transmissions while the UE 315 is in the inactive mode. In some aspects, one or more of the SDT communications communicated at action 320 may include SDT data. In another aspect, one or more of the SDT communications communicated at action 320 include SDT signals. In some aspects, action 320 may comprise the first BS 305a transmitting, to the second BS 305b via a RRC Transfer message, one or more UL SDT signals. The second BS 305b may then transmit, to the AFM 301 via a UL NAS Transport message, a UL NAS PDU including the UL SDT signal. In another aspect, action 320 may comprise the first BS 305a transmitting UL SDT data to the first BS 305a via a PUSCH communication, the first BS 305a forwarding the UL SDT data to the second BS 305b via a Xn communication, and the second BS 305b forwarding the UL SDT data to the UPF 303 via a NG-U communication.

At action 322, the second BS 305b receives, while the UE 315 remains in the inactive mode, DL non-SDT data and/or a DL non-SDT signal. In some aspects, the second BS 305b receives the DL non-SDT data and/or signal in a buffer of a radio bearer not enabled for SDT communications.

At action 324, the second BS 305b transmits, and the first BS 305a receives, a connection management or mobility message indicating the arrival of the DL non-SDT communication at the second BS 305b. In some aspects, the connection management message may comprise a Retrieve UE Context Response message. The message may include an indicator of the arrival DL non-SDT data and/or signal. The message may be an Xn message. For example, in some aspects, the Retrieve UE Context Response message may include at least one field for indicating whether non-SDT data is scheduled for transmission to the UE 315. In some aspects, the Retrieve UE Context Response includes or indicates UE context information such that the full UE context is moved to the first BS 305a.

At action 326, the first BS 305a transmits, and the UE 315 receives, a random access message to cause the UE 315 to transition to a connected mode or state. For example, the random access message may comprise a RRCResume message configured to cause the UE to move to a RRC_CONNECTED state. In some aspects, the RRCResume message may be ciphered based on a key associated with the first BS 305a. In some aspects, the first BS 305a may cipher the RRCResume message after performing a security key refresh. For example, the first BS 305a may perform a horizontal key update to refresh its security key, and cipher the RRCResume message based on the updated key.

At action 328, the UE 315 transitions to a connected state. For example, action 328 may include the UE 315 moving or transitioning to the RRC_CONNECTED state. In some aspects, the UE 315 may increase monitoring, signaling, and/or other communication procedures based on moving to the connected state.

At action 330, the UE 315 may transmit, to the first BS 305a based on moving to the connected state, a connection complete message indicating that the move to the connected mode is complete. For example, the UE 315 may transmit a RRCResumeComplete message to the first BS 305a.

In some aspects, the first BS 305a may indicate to the second BS 305b, the AMF 301, and/or the UPF 303 that the UE 315 has moved into the connected state. For example, the first BS 305a may transmit at least one of a Xn message or a NG message indicating that the UE 315 has moved to the RRC_CONNECTED state. In another aspect, the method 300a may further include the second BS 305b transmitting, to the first BS 305a, the DL non-SDT data and/or signaling for transmission to the UE 315. Further, the method 300a may include the first BS 305a transmitting, and the UE 315 receiving, the DL non-SDT communication while in the connected mode. In some aspects, the method 300a may include the first BS 305a establishing a PDCP entity and handling any further or ongoing SDT communications. In some aspects, any PDCP PDUs which were prepared or ciphered using old keys may be retransmitted.

Referring to the method 300b of FIG. 3B, at action 302, the UE 315 is in an inactive mode or state. For example, the UE 315 may be in a radio resource control (RRC) inactive state (RRC_INACTIVE) and in a connection management connected state (CM-CONNECTED). In other aspects, the UE 315 may be in an idle mode at action 302, such as RRC_IDLE. In the inactive mode, the UE 315 may perform limited or reduced signaling and/or monitoring to reduce power consumption. In some aspects, the UE 315 may transition to the inactive mode in response to receiving a release and/or suspend message while in a connected mode.

At action 304, the UE 315 transmits, and the first BS 305a receives, a random access communication including uplink (UL) SDT data and/or signaling. In some aspects, the random access communication comprises a connection request or resume connection request. In some aspects, the message includes a RRCResumeRequest message. In some aspects, the random access communication comprises a RACH preamble. In other aspects, the random access communication comprises a combination of a RRCResumeRequest message and a RACH preamble. The UL SDT data and/or signaling may be included with the random access communication in a single message or transmission. For example, the UE 315 may transmit the RRCResumeRequest message and the UL SDT data and/or signaling in a same physical uplink shared channel (PUSCH) transmission. In other aspects, the random access communication and the UL SDT data and/or signaling may be carried in separate messages or communications.

At action 306, the first BS 305a transmits, to the second BS 305b in response to receiving the random access communication and UL SDT data and/or signaling at action 304, a request to retrieve UE context. In some aspects, transmitting the request may comprise transmitting a RETREIVE UE CONTEXT REQUEST message. In some aspects, the message may include an SDT indicator indicating the arrival of the UL SDT data and/or signaling. The message may further include UE assistance information. The UE assistance information may be based on the communication received by the first BS 305a at action 304. In some aspects, the request to retrieve the UE context may comprise a Xn message.

At action 308, the second BS 305b determines or decides to keep at least a portion of the UE context. In this regard, the second BS 305b may determine not to transfer the complete UE context to the first BS 305a. For example, the second BS 305b may determine to transmit a portion of the UE context. For example, the second BS 305b may determine to transfer a first portion of the UE context so that the first BS 305a may establish a SDT radio bearer, such as a data radio bearer (DRB) or a signaling radio bearer (SRB). The second BS 305b may retain a portion of the UE context to establish a packet data convergence protocol (PDCP) entity.

At action 310, the second BS 305b transmits, and the first BS 305a receives, a partial UE context transfer. The partial UE context transfer may include UE identifiers, UE capability information, configuration parameters, subscription information, security information, and/or other information associated with the UE to enable the first BS 305a to receive, decode, and/or transfer the SDT data and/or signaling. In some aspects, the partial UE context transfer may be transmitted using a Xn message.

At action 312, the first BS 305a transmits, to the second BS 305b, a partial UE context transfer acknowledge message. In some aspects, the partial UE context transfer acknowledge message may comprise a Xn message. In some aspects, the partial UE context transfer acknowledge message may indicate that the partial UE context was received by the first BS 305a.

At action 314, the first BS 305a establishes, based on the partial UE context transfer, a SDT RLC entity. In some aspects, the SDT RLC entity is based on the partial UE context received from the second BS 305b. In some aspects, the SDT RLC entity may enable the first BS 305a to receive, forward, decode, and/or otherwise handle SDT data and/or signaling to and from the UE 315.

At action 316, the second BS 305b establishes or retains a PDCP entity based on the portion of the UE context retained by the second BS 305b. In some aspects, the PDCP entity may enable the second BS 305b to receive, decode, forward, and/or otherwise handle non-SDT communications to and from the UE 315.

At action 318, the first BS 305a transmits the UL SDT data and/or signaling received at action 304 to the second BS 305b. In some aspects, transmitting the UL SDT communication may comprise the first BS 305a transmitting the UL SDT communication to the second BS 305b in a Xn message. The second BS 305b forwards or transfers the UL SDT communication to the UPF 303. In some aspects, the transfer of the SDT communication to the UPF 303 may be based on a NG interface. For example, the second BS 305b may forward the UL SDT communication to the UPF 303 in a NG-U message. In another aspect, the second BS 305b may forward the UL SDT communication to the AMF 301 in a NG-C message.

At action 320, the UE 315, first BS 305a, second BS 305b, the AMF 301, and/or the UPF 303 perform additional UL and/or DL SDT transmissions while the UE 315 is in the inactive mode. In some aspects, one or more of the SDT communications communicated at action 320 may include SDT data. In another aspect, one or more of the SDT communications communicated at action 320 include SDT signals. In some aspects, action 320 may comprise the first BS 305a transmitting, to the second BS 305b via a RRC Transfer message, one or more UL SDT signals. The second BS 305b may then transmit, to the AFM 301 via a UL NAS Transport message, a UL NAS PDU including the UL SDT signal. In another aspect, action 320 may comprise the first BS 305a transmitting UL SDT data to the first BS 305a via a PUSCH communication, the first BS 305a forwarding the UL SDT data to the second BS 305b via a Xn communication, and the second BS 305b forwarding the UL SDT data to the UPF 303 via a NG-U communication.

At action 322, the second BS 305b receives, while the UE 315 remains in the inactive mode, DL non-SDT data and/or a DL non-SDT signal. In some aspects, the second BS 305b receives the DL non-SDT data and/or signal in a buffer of a radio bearer not enabled for SDT communications.

At action 324, the second BS 305b transmits, and the first BS 305a receives, a message indicating the arrival of the DL non-SDT communication at the second BS 305b. In some aspects, the message may comprise an ACTIVITY NOTIFICATION message. The message may include an indicator of the arrival DL non-SDT data and/or signal. The message may be an Xn message. For example, in some aspects, the ACTIVITY NOTIFICATION message may include at least one field for indicating whether non-SDT data is scheduled for transmission to the UE 315.

In the method 300b, the first BS 305a currently serving the UE 315 may be configured or otherwise responsible for determining whether to retrieve the full UE context from the first BS 305a, and whether to cause the UE 315 to move to the connected mode. Accordingly, at action 326, the first BS 305a transmits, based on receiving the DL non-SDT indication, a request for full UE context relocation to the first BS 305a. For example, the first BS 305a may transmit a Xn message to the second BS 305b requesting the full UE context.

At action 328, the second BS 305b transmits, to the first BS 305a based on receiving the request for full UE context relocation, the complete UE context. In some aspects, action 328 comprises transmitting a RETRIEVE UE CONTEXT RESPONSE message including or indicating the full UE context. In other aspects, the second BS 305b may transmit a different Xn message including or indicating the UE context. In some aspects, the UE context included in the message transmitted at action 328 may include only the portion of the UE context that has not yet been relocated to the first BS 305a from action 310. In other aspects, action 328 comprises transmitted the complete, or full, UE context. In some aspects, based on receiving the full UE context, the first BS 305a may establish a PDCP entity and/or any other entity for handling non-SDT communications between the network and the UE 315.

At action 330, the first BS 305a transmits, and the UE 315 receives, a random access message to cause the UE 315 to transition to a connected mode or state. For example, the random access message may comprise a RRCResume message configured to cause the UE to move to a RRC_CONNECTED state. The RRCResume message may be ciphered based on a key associated with the first BS 305a.

At action 332, the UE 315 transitions to a connected state. For example, action 332 may include the UE 315 moving or transitioning to the RRC_CONNECTED state. In some aspects, the UE 315 may increase monitoring, signaling, and/or other communication procedures based on moving to the connected state.

In some aspects, the method 300b may further comprise the UE 315 transmitting, to the first BS 305a based on moving to the connected state, a connection complete message indicating that the move to the connected mode is complete. For example, the UE 315 may transmit a RRCResumeComplete message to the first BS 305a. In some aspects, the first BS 305a may indicate to the second BS 305b, the AMF 301, and/or the UPF 303 that the UE 315 has moved into the connected state. For example, the first BS 305a may transmit at least one of a Xn message or a NG message indicating that the UE 315 has moved to the RRC_CONNECTED state. In another aspect, the method 300b may further include the second BS 305b transmitting, to the first BS 305a, the DL non-SDT data and/or signaling for transmission to the UE 315. Further, the method 300b may include the first BS 305a transmitting, and the UE 315 receiving, the DL non-SDT communication while in the connected mode.

Referring to the method 300c of FIG. 3C, at action 302, the UE 315 is in an inactive mode or state. For example, the UE 315 may be in a radio resource control (RRC) inactive state (RRC_INACTIVE) and in a connection management connected state (CM-CONNECTED). In other aspects, the UE 315 may be in an idle mode at action 302, such as RRC IDLE. In the inactive mode, the UE 315 may perform limited or reduced signaling and/or monitoring to reduce power consumption. In some aspects, the UE 315 may transition to the inactive mode in response to receiving a release and/or suspend message while in a connected mode.

At action 304, the UE 315 transmits, and the first BS 305a receives, a random access communication including uplink (UL) SDT data and/or signaling. In some aspects, the random access communication comprises a connection request or resume connection request. In some aspects, the message includes a RRCResumeRequest message. In some aspects, the random access communication comprises a RACH preamble. In other aspects, the random access communication comprises a combination of a RRCResumeRequest message and a RACH preamble. The UL SDT data and/or signaling may be included with the random access communication in a single message or transmission. For example, the UE 315 may transmit the RRCResumeRequest message and the UL SDT data and/or signaling in a same physical uplink shared channel (PUSCH) transmission. In other aspects, the random access communication and the UL SDT data and/or signaling may be carried in separate messages or communications.

At action 306, the first BS 305a transmits, to the second BS 305b in response to receiving the random access communication and UL SDT data and/or signaling at action 304, a request to retrieve UE context. In some aspects, transmitting the request may comprise transmitting a RETREIVE UE CONTEXT REQUEST message. In some aspects, the message may include an SDT indicator indicating the arrival of the UL SDT data and/or signaling. The message may further include UE assistance information. The UE assistance information may be based on the communication received by the first BS 305a at action 304. In some aspects, the request to retrieve the UE context may comprise a Xn message.

At action 308, the second BS 305b determines or decides to keep at least a portion of the UE context. In this regard, the second BS 305b may determine not to transfer the complete UE context to the first BS 305a. For example, the second BS 305b may determine to transmit a portion of the UE context. For example, the second BS 305b may determine to transfer a first portion of the UE context so that the first BS 305a may establish a SDT radio bearer, such as a data radio bearer (DRB) or a signaling radio bearer (SRB). The second BS 305b may retain a portion of the UE context to establish a packet data convergence protocol (PDCP) entity.

At action 310, the second BS 305b transmits, and the first BS 305a receives, a partial UE context transfer. The partial UE context transfer may include UE identifiers, UE capability information, configuration parameters, subscription information, security information, and/or other information associated with the UE to enable the first BS 305a to receive, decode, and/or transfer the SDT data and/or signaling. In some aspects, the partial UE context transfer may be transmitted using a Xn message.

At action 312, the first BS 305a transmits, to the second BS 305b, a partial UE context transfer acknowledge message. In some aspects, the partial UE context transfer acknowledge message may comprise a Xn message. In some aspects, the partial UE context transfer acknowledge message may indicate that the partial UE context was received by the first BS 305a.

At action 314, the first BS 305a establishes, based on the partial UE context transfer, a SDT RLC entity. In some aspects, the SDT RLC entity is based on the partial UE context received from the second BS 305b. In some aspects, the SDT RLC entity may enable the first BS 305a to receive, forward, decode, and/or otherwise handle SDT data and/or signaling to and from the UE 315.

At action 316, the second BS 305b establishes or retains a PDCP entity based on the portion of the UE context retained by the second BS 305b. In some aspects, the PDCP entity may enable the second BS 305b to receive, decode, forward, and/or otherwise handle non-SDT communications to and from the UE 315.

At action 318, the first BS 305a transmits the UL SDT data and/or signaling received at action 304 to the second BS 305b. In some aspects, transmitting the UL SDT communication may comprise the first BS 305a transmitting the UL SDT communication to the second BS 305b in a Xn message. The second BS 305b forwards or transfers the UL SDT communication to the UPF 303. In some aspects, the transfer of the SDT communication to the UPF 303 may be based on a NG interface. For example, the second BS 305b may forward the UL SDT communication to the UPF 303 in a NG-U message. In another aspect, the second BS 305b may forward the UL SDT communication to the AMF 301 in a NG-C message.

At action 320, the UE 315, first BS 305a, second BS 305b, the AMF 301, and/or the UPF 303 perform additional UL and/or DL SDT transmissions while the UE 315 is in the inactive mode. In some aspects, one or more of the SDT communications communicated at action 320 may include SDT data. In another aspect, one or more of the SDT communications communicated at action 320 include SDT signals. In some aspects, action 320 may comprise the first BS 305a transmitting, to the second BS 305b via a RRC Transfer message, one or more UL SDT signals. The second BS 305b may then transmit, to the AFM 301 via a UL NAS Transport message, a UL NAS PDU including the UL SDT signal. In another aspect, action 320 may comprise the first BS 305a transmitting UL SDT data to the first BS 305a via a PUSCH communication, the first BS 305a forwarding the UL SDT data to the second BS 305b via a Xn communication, and the second BS 305b forwarding the UL SDT data to the UPF 303 via a NG-U communication.

At action 322, the second BS 305b receives, while the UE 315 remains in the inactive mode, DL non-SDT data and/or a DL non-SDT signal. In some aspects, the second BS 305b receives the DL non-SDT data and/or signal in a buffer of a radio bearer not enabled for SDT communications.

At action 324, the second BS 305b transmits, and the first BS 305a receives, a message indicating the arrival of the DL non-SDT communication at the second BS 305b. In some aspects, the message may comprise an ACTIVITY NOTIFICATION message. The message may include an indicator of the arrival DL non-SDT data and/or signal. The message may be an Xn message. For example, in some aspects, the ACTIVITY NOTIFICATION message may include at least one field for indicating whether non-SDT data is scheduled for transmission to the UE 315.

In the method 300c, the first BS 305a currently serving the UE 315 may be configured or otherwise responsible for determining whether to retrieve the full UE context from the first BS 305a, and whether to cause the UE 315 to move to the connected mode. Accordingly, at action 326, the first BS 305a transmits, based on receiving the DL non-SDT indication, a request for full UE context relocation to the first BS 305a. For example, the first BS 305a may transmit a Xn message to the second BS 305b requesting the full UE context. In another aspect, the communication of action 326 further comprises a pre-ciphered or unciphered RRCResume message and a request for the second BS 305b to cipher and return the RRCResume message.

At action 328, the second BS 305b transmits, to the first BS 305a based on receiving the request for full UE context relocation, the complete UE context and the ciphered RRCResume message. In some aspects, the RRCResume message is ciphered based on the second BSs' 305b key. In some aspects, action 328 comprises transmitting a RETRIEVE UE CONTEXT RESPONSE message including or indicating the full UE context. In other aspects, the second BS 305b may transmit a different Xn message including or indicating the UE context. In some aspects, the UE context included in the message transmitted at action 328 may include only the portion of the UE context that has not yet been relocated to the first BS 305a from action 310. In other aspects, action 328 comprises transmitted the complete, or full, UE context. In some aspects, based on receiving the full UE context, the first BS 305a may establish a PDCP entity and/or any other entity for handling non-SDT communications between the network and the UE 315.

At action 330, the first BS 305a transmits, and the UE 315 receives, the ciphered RRCResume message. The ciphered RRCResume message may cause the UE 315 to transition to a connected mode or state. For example, the ciphered RRCResume message may cause the UE to move to a RRC_CONNECTED state.

At action 332, the UE 315 transitions to a connected state. For example, action 332 may include the UE 315 moving or transitioning to the RRC_CONNECTED state. In some aspects, the UE 315 may increase monitoring, signaling, and/or other communication procedures based on moving to the connected state.

In some aspects, the method 300c may further comprise the UE 315 transmitting, to the first BS 305a based on moving to the connected state, a connection complete message indicating that the move to the connected mode is complete. For example, the UE 315 may transmit a RRCResumeComplete message to the first BS 305a. In some aspects, the first BS 305a may indicate to the second BS 305b, the AMF 301, and/or the UPF 303 that the UE 315 has moved into the connected state. For example, the first BS 305a may transmit at least one of a Xn message or a NG message indicating that the UE 315 has moved to the RRC_CONNECTED state. In another aspect, the method 300c may further include the second BS 305b transmitting, to the first BS 305a, the DL non-SDT data and/or signaling for transmission to the UE 315. Further, the method 300c may include the first BS 305a transmitting, and the UE 315 receiving, the DL non-SDT communication while in the connected mode.

Referring to the method 300d shown in FIG. 3D, at action 302, the UE 315 is in an inactive mode or state. For example, the UE 315 may be in a radio resource control (RRC) inactive state (RRC_INACTIVE) and in a connection management connected state (CM-CONNECTED). In other aspects, the UE 315 may be in an idle mode at action 302, such as RRC_IDLE. In the inactive mode, the UE 315 may perform limited or reduced signaling and/or monitoring to reduce power consumption. In some aspects, the UE 315 may transition to the inactive mode in response to receiving a release and/or suspend message while in a connected mode.

At action 304, the UE 315 transmits, and the first BS 305a receives, a random access communication including uplink (UL) SDT data and/or signaling. In some aspects, the random access communication comprises a connection request or resume connection request. In some aspects, the message includes a RRCResumeRequest message. In some aspects, the random access communication comprises a RACH preamble. In other aspects, the random access communication comprises a combination of a RRCResumeRequest message and a RACH preamble. The UL SDT data and/or signaling may be included with the random access communication in a single message or transmission. For example, the UE 315 may transmit the RRCResumeRequest message and the UL SDT data and/or signaling in a same physical uplink shared channel (PUSCH) transmission. In other aspects, the random access communication and the UL SDT data and/or signaling may be carried in separate messages or communications.

At action 306, the first BS 305a transmits, to the second BS 305b in response to receiving the random access communication and UL SDT data and/or signaling at action 304, a request to retrieve UE context. In some aspects, transmitting the request may comprise transmitting a RETREIVE UE CONTEXT REQUEST message. In some aspects, the message may include an SDT indicator indicating the arrival of the UL SDT data and/or signaling. The message may further include UE assistance information. The UE assistance information may be based on the communication received by the first BS 305a at action 304. In some aspects, the request to retrieve the UE context may comprise a Xn message.

At action 308, the second BS 305b determines or decides to keep at least a portion of the UE context. In this regard, the second BS 305b may determine not to transfer the complete UE context to the first BS 305a. For example, the second BS 305b may determine to transmit a portion of the UE context. For example, the second BS 305b may determine to transfer a first portion of the UE context so that the first BS 305a may establish a SDT radio bearer, such as a data radio bearer (DRB) or a signaling radio bearer (SRB). The second BS 305b may retain a portion of the UE context to establish a packet data convergence protocol (PDCP) entity.

At action 310, the second BS 305b transmits, and the first BS 305a receives, a partial UE context transfer. The partial UE context transfer may include UE identifiers, UE capability information, configuration parameters, subscription information, security information, and/or other information associated with the UE to enable the first BS 305a to receive, decode, and/or transfer the SDT data and/or signaling. In some aspects, the partial UE context transfer may be transmitted using a Xn message.

At action 312, the first BS 305a transmits, to the second BS 305b, a partial UE context transfer acknowledge message. In some aspects, the partial UE context transfer acknowledge message may comprise a Xn message. In some aspects, the partial UE context transfer acknowledge message may indicate that the partial UE context was received by the first BS 305a.

At action 314, the first BS 305a establishes, based on the partial UE context transfer, a SDT RLC entity. In some aspects, the SDT RLC entity is based on the partial UE context received from the second BS 305b. In some aspects, the SDT RLC entity may enable the first BS 305a to receive, forward, decode, and/or otherwise handle SDT data and/or signaling to and from the UE 315.

At action 316, the second BS 305b establishes or retains a PDCP entity based on the portion of the UE context retained by the second BS 305b. In some aspects, the PDCP entity may enable the second BS 305b to receive, decode, forward, and/or otherwise handle non-SDT communications to and from the UE 315.

At action 318, the first BS 305a transmits the UL SDT data and/or signaling received at action 304 to the second BS 305b. In some aspects, transmitting the UL SDT communication may comprise the first BS 305a transmitting the UL SDT communication to the second BS 305b in a Xn message. The second BS 305b forwards or transfers the UL SDT communication to the UPF 303. In some aspects, the transfer of the SDT communication to the UPF 303 may be based on a NG interface. For example, the second BS 305b may forward the UL SDT communication to the UPF 303 in a NG-U message. In another aspect, the second BS 305b may forward the UL SDT communication to the AMF 301 in a NG-C message.

At action 320, the UE 315, first BS 305a, second BS 305b, the AMF 301, and/or the UPF 303 perform additional UL and/or DL SDT transmissions while the UE 315 is in the inactive mode. In some aspects, one or more of the SDT communications communicated at action 320 may include SDT data. In another aspect, one or more of the SDT communications communicated at action 320 include SDT signals. In some aspects, action 320 may comprise the first BS 305a transmitting, to the second BS 305b via a RRC Transfer message, one or more UL SDT signals. The second BS 305b may then transmit, to the AFM 301 via a UL NAS Transport message, a UL NAS PDU including the UL SDT signal. In another aspect, action 320 may comprise the first BS 305a transmitting UL SDT data to the first BS 305a via a PUSCH communication, the first BS 305a forwarding the UL SDT data to the second BS 305b via a Xn communication, and the second BS 305b forwarding the UL SDT data to the UPF 303 via a NG-U communication.

At action 322, the second BS 305b receives, while the UE 315 remains in the inactive mode, DL non-SDT data and/or a DL non-SDT signal. In some aspects, the second BS 305b receives the DL non-SDT data and/or signal in a buffer of a radio bearer not enabled for SDT communications.

At action 324, the second BS 305b transmits, and the first BS 305a receives, a release message for the UE 315 to cause the UE 315 to suspend the RRC Resume procedure. In some aspects, action 324 comprises transmitting a RETRIEVE UE CONTEXT FAILURE message indicating that the full UE context will not be transferred to the first BS 305a. In some aspects, action 324 also comprises transmitted a RRCRelease message to the first BS 305a. The RRCRelease message may be ciphered based on a key associated with the second BS 305b. The message and/or messages transmitted at action 324 may also indicate the arrival of the DL non-SDT communication at the second BS 305b. The message or messages may be Xn messages. For example, in some aspects, the RETRIEVE UE CONTEXT FAILURE message may include at least one field for indicating whether non-SDT data is scheduled for transmission to the UE 315.

At action 326, the first BS 305a transmits, and the UE 315 receives, a random access message to cause the UE 315 to remain in the inactive mode or state such that the RRCResume procedure is suspended. For example, the random access message may comprise a RRCRelease message comprising a suspend config indication to cause the UE to remain in or return to the RRC_INACTIVE state. In some aspects, the RRCRelease message may be ciphered based on a key associated with the second BS 305b. In other aspects, the RRCRelease message may be ciphered based on a key associated with the first BS 305a. Further, the RRCRelease message may include an indication of the arrival of the DL non-SDT communication.

At action 328, the UE 315 remains in or returns to the inactive mode. For example, action 328 may include the UE 315 remaining in the RRC_INACTIVE state.

At action 330, the UE 315 may initiate, based on receiving the RRCRelease message and returning to the inactive mode, a random access procedure. For example, the UE 315 may transmit, to the first BS 305a, a RACH preamble. In some aspects, the UE 315 may initiate a two-step RACH procedure. In other aspects, the UE 315 may initiate a four-step RACH procedure.

In some aspects, the method 300d may provide for an expedited re-initiation of a RACH procedure such that the UE 315 may transition to the connected mode in an expedited fashion for quicker receipt of the DL non-SDT data and/or signaling indicated to the UE 315 at action 326. In other words, the UE 315 may be made aware that the reason for the SDT termination was due to the arrival of the DL non-SDT communication. In some aspects, the UE 315 may adapt or modify its SDT procedures based on the indication of the arrival of the non-SDT data and/or signaling. For example, the UE 315 may, in the future, refrain from SDT protocols in favor of returning to the connected mode for SDT and/or non-SDT communications.

Referring to the method 300e shown in FIG. 3E, at action 302, the UE 315 is in an inactive mode or state. For example, the UE 315 may be in a radio resource control (RRC) inactive state (RRC_INACTIVE) and in a connection management connected state (CM-CONNECTED). In other aspects, the UE 315 may be in an idle mode at action 302, such as RRC_IDLE. In the inactive mode, the UE 315 may perform limited or reduced signaling and/or monitoring to reduce power consumption. In some aspects, the UE 315 may transition to the inactive mode in response to receiving a release and/or suspend message while in a connected mode.

At action 304, the UE 315 transmits, and the first BS 305a receives, a random access communication including uplink (UL) SDT data and/or signaling. In some aspects, the random access communication comprises a connection request or resume connection request. In some aspects, the message includes a RRCResumeRequest message. In some aspects, the random access communication comprises a RACH preamble. In other aspects, the random access communication comprises a combination of a RRCResumeRequest message and a RACH preamble. The UL SDT data and/or signaling may be included with the random access communication in a single message or transmission. For example, the UE 315 may transmit the RRCResumeRequest message and the UL SDT data and/or signaling in a same physical uplink shared channel (PUSCH) transmission. In other aspects, the random access communication and the UL SDT data and/or signaling may be carried in separate messages or communications.

At action 306, the first BS 305a transmits, to the second BS 305b in response to receiving the random access communication and UL SDT data and/or signaling at action 304, a request to retrieve UE context. In some aspects, transmitting the request may comprise transmitting a RETREIVE UE CONTEXT REQUEST message. In some aspects, the message may include an SDT indicator indicating the arrival of the UL SDT data and/or signaling. The message may further include UE assistance information. The UE assistance information may be based on the communication received by the first BS 305a at action 304. In some aspects, the request to retrieve the UE context may comprise a Xn message.

At action 308, the second BS 305b determines or decides to keep at least a portion of the UE context. In this regard, the second BS 305b may determine not to transfer the complete UE context to the first BS 305a. For example, the second BS 305b may determine to transmit a portion of the UE context. For example, the second BS 305b may determine to transfer a first portion of the UE context so that the first BS 305a may establish a SDT radio bearer, such as a data radio bearer (DRB) or a signaling radio bearer (SRB). The second BS 305b may retain a portion of the UE context to establish a packet data convergence protocol (PDCP) entity.

At action 310, the second BS 305b transmits, and the first BS 305a receives, a partial UE context transfer. The partial UE context transfer may include UE identifiers, UE capability information, configuration parameters, subscription information, security information, and/or other information associated with the UE to enable the first BS 305a to receive, decode, and/or transfer the SDT data and/or signaling. In some aspects, the partial UE context transfer may be transmitted using a Xn message.

At action 312, the first BS 305a transmits, to the second BS 305b, a partial UE context transfer acknowledge message. In some aspects, the partial UE context transfer acknowledge message may comprise a Xn message. In some aspects, the partial UE context transfer acknowledge message may indicate that the partial UE context was received by the first BS 305a.

At action 314, the first BS 305a establishes, based on the partial UE context transfer, a SDT RLC entity. In some aspects, the SDT RLC entity is based on the partial UE context received from the second BS 305b. In some aspects, the SDT RLC entity may enable the first BS 305a to receive, forward, decode, and/or otherwise handle SDT data and/or signaling to and from the UE 315.

At action 316, the second BS 305b establishes or retains a PDCP entity based on the portion of the UE context retained by the second BS 305b. In some aspects, the PDCP entity may enable the second BS 305b to receive, decode, forward, and/or otherwise handle non-SDT communications to and from the UE 315.

At action 318, the first BS 305a transmits the UL SDT data and/or signaling received at action 304 to the second BS 305b. In some aspects, transmitting the UL SDT communication may comprise the first BS 305a transmitting the UL SDT communication to the second BS 305b in a Xn message. The second BS 305b forwards or transfers the UL SDT communication to the UPF 303. In some aspects, the transfer of the SDT communication to the UPF 303 may be based on a NG interface. For example, the second BS 305b may forward the UL SDT communication to the UPF 303 in a NG-U message. In another aspect, the second BS 305b may forward the UL SDT communication to the AMF 301 in a NG-C message.

At action 320, the UE 315, first BS 305a, second BS 305b, the AMF 301, and/or the UPF 303 perform additional UL and/or DL SDT transmissions while the UE 315 is in the inactive mode. In some aspects, one or more of the SDT communications communicated at action 320 may include SDT data. In another aspect, one or more of the SDT communications communicated at action 320 include SDT signals. In some aspects, action 320 may comprise the first BS 305a transmitting, to the second BS 305b via a RRC Transfer message, one or more UL SDT signals. The second BS 305b may then transmit, to the AFM 301 via a UL NAS Transport message, a UL NAS PDU including the UL SDT signal. In another aspect, action 320 may comprise the first BS 305a transmitting UL SDT data to the first BS 305a via a PUSCH communication, the first BS 305a forwarding the UL SDT data to the second BS 305b via a Xn communication, and the second BS 305b forwarding the UL SDT data to the UPF 303 via a NG-U communication.

At action 322, the second BS 305b receives, while the UE 315 remains in the inactive mode, DL non-SDT data and/or a DL non-SDT signal. In some aspects, the second BS 305b receives the DL non-SDT data and/or signal in a buffer of a radio bearer not enabled for SDT communications.

At action 324, the second BS 305b transmits, and the first BS 305a receives, a release message for the UE 315 to cause the UE 315 to suspend the RRC Resume procedure. In some aspects, action 324 comprises transmitting a RETRIEVE UE CONTEXT FAILURE message indicating that the full UE context will not be transferred to the first BS 305a. In some aspects, action 324 also comprises transmitted a RRCRelease message to the first BS 305a. The RRCRelease message may be ciphered based on a key associated with the second BS 305b. The message and/or messages transmitted at action 324 may also indicate the arrival of the DL non-SDT communication at the second BS 305b. The message or messages may be Xn messages. For example, in some aspects, the RETRIEVE UE CONTEXT FAILURE message may include at least one field for indicating whether non-SDT data is scheduled for transmission to the UE 315.

In another aspect, the release message may include or indicate contention free RACH (CFRA) resources for the UE 315 to use to expedite a new RRCResume procedure to move into the connected mode. The CFRA resources may include time and/or frequency resources for the UE to transmit one or more random access communications, such as a RACH preamble.

At action 326, the first BS 305a transmits, and the UE 315 receives, a random access message to cause the UE 315 to remain in the inactive mode or state such that the RRCResume procedure is suspended. For example, the random access message may comprise a RRCRelease message comprising a suspend config indication to cause the UE to remain in or return to the RRC_INACTIVE state. In some aspects, the RRCRelease message may be ciphered based on a key associated with the second BS 305b. In other aspects, the RRCRelease message may be ciphered based on a key associated with the first BS 305a. Further, the RRCRelease message may include an indication of the arrival of the DL non-SDT communication. In another aspect, the random access message transmitted at action 326 may include or indicate the CFRA resources indicated at action 324.

At action 328, the UE 315 remains in or returns to the inactive mode. For example, action 328 may include the UE 315 remaining in the RRC_INACTIVE state.

At action 330, the UE 315 may initiate, based on receiving the RRCRelease message and returning to the inactive mode, a random access procedure using the indicated CFRA resources. For example, the UE 315 may transmit, to the first BS 305a, a RACH preamble using the CFRA resources. In some aspects, the UE 315 may initiate a two-step RACH procedure. In other aspects, the UE 315 may initiate a four-step RACH procedure.

In some aspects, the method 300e may provide for an expedited re-initiation of a RACH procedure such that the UE 315 may transition to the connected mode in an expedited fashion for quicker receipt of the DL non-SDT data and/or signaling indicated to the UE 315 at action 326. In other words, the UE 315 may be made aware that the reason for the SDT termination was due to the arrival of the DL non-SDT communication. In some aspects, the UE 315 may adapt or modify its SDT procedures based on the indication of the arrival of the non-SDT data and/or signaling. For example, the UE 315 may, in the future, refrain from SDT protocols in favor of returning to the connected mode for SDT and/or non-SDT communications.

Referring to the method 300f shown in FIG. 3F, at action 302, the UE 315 is in an inactive mode or state. For example, the UE 315 may be in a radio resource control (RRC) inactive state (RRC_INACTIVE) and in a connection management connected state (CM-CONNECTED). In other aspects, the UE 315 may be in an idle mode at action 302, such as RRC_IDLE. In the inactive mode, the UE 315 may perform limited or reduced signaling and/or monitoring to reduce power consumption. In some aspects, the UE 315 may transition to the inactive mode in response to receiving a release and/or suspend message while in a connected mode.

At action 304, the UE 315 transmits, and the first BS 305a receives, a random access communication including uplink (UL) SDT data and/or signaling. In some aspects, the random access communication comprises a connection request or resume connection request. In some aspects, the message includes a RRCResumeRequest message. In some aspects, the random access communication comprises a RACH preamble. In other aspects, the random access communication comprises a combination of a RRCResumeRequest message and a RACH preamble. The UL SDT data and/or signaling may be included with the random access communication in a single message or transmission. For example, the UE 315 may transmit the RRCResumeRequest message and the UL SDT data and/or signaling in a same physical uplink shared channel (PUSCH) transmission. In other aspects, the random access communication and the UL SDT data and/or signaling may be carried in separate messages or communications.

At action 306, the first BS 305a transmits, to the second BS 305b in response to receiving the random access communication and UL SDT data and/or signaling at action 304, a request to retrieve UE context. In some aspects, transmitting the request may comprise transmitting a RETREIVE UE CONTEXT REQUEST message. In some aspects, the message may include an SDT indicator indicating the arrival of the UL SDT data and/or signaling. The message may further include UE assistance information. The UE assistance information may be based on the communication received by the first BS 305a at action 304. In some aspects, the request to retrieve the UE context may comprise a Xn message.

At action 308, the second BS 305b determines or decides to keep at least a portion of the UE context. In this regard, the second BS 305b may determine not to transfer the complete UE context to the first BS 305a. For example, the second BS 305b may determine to transmit a portion of the UE context. For example, the second BS 305b may determine to transfer a first portion of the UE context so that the first BS 305a may establish a SDT radio bearer, such as a data radio bearer (DRB) or a signaling radio bearer (SRB). The second BS 305b may retain a portion of the UE context to establish a packet data convergence protocol (PDCP) entity.

At action 310, the second BS 305b transmits, and the first BS 305a receives, a partial UE context transfer. The partial UE context transfer may include UE identifiers, UE capability information, configuration parameters, subscription information, security information, and/or other information associated with the UE to enable the first BS 305a to receive, decode, and/or transfer the SDT data and/or signaling. In some aspects, the partial UE context transfer may be transmitted using a Xn message.

At action 312, the first BS 305a transmits, to the second BS 305b, a partial UE context transfer acknowledge message. In some aspects, the partial UE context transfer acknowledge message may comprise a Xn message. In some aspects, the partial UE context transfer acknowledge message may indicate that the partial UE context was received by the first BS 305a.

At action 314, the first BS 305a establishes, based on the partial UE context transfer, a SDT RLC entity. In some aspects, the SDT RLC entity is based on the partial UE context received from the second BS 305b. In some aspects, the SDT RLC entity may enable the first BS 305a to receive, forward, decode, and/or otherwise handle SDT data and/or signaling to and from the UE 315.

At action 316, the second BS 305b establishes or retains a PDCP entity based on the portion of the UE context retained by the second BS 305b. In some aspects, the PDCP entity may enable the second BS 305b to receive, decode, forward, and/or otherwise handle non-SDT communications to and from the UE 315.

At action 318, the first BS 305a transmits the UL SDT data and/or signaling received at action 304 to the second BS 305b. In some aspects, transmitting the UL SDT communication may comprise the first BS 305a transmitting the UL SDT communication to the second BS 305b in a Xn message. The second BS 305b forwards or transfers the UL SDT communication to the UPF 303. In some aspects, the transfer of the SDT communication to the UPF 303 may be based on a NG interface. For example, the second BS 305b may forward the UL SDT communication to the UPF 303 in a NG-U message. In another aspect, the second BS 305b may forward the UL SDT communication to the AMF 301 in a NG-C message.

At action 320, the UE 315, first BS 305a, second BS 305b, the AMF 301, and/or the UPF 303 perform additional UL and/or DL SDT transmissions while the UE 315 is in the inactive mode. In some aspects, one or more of the SDT communications communicated at action 320 may include SDT data. In another aspect, one or more of the SDT communications communicated at action 320 include SDT signals. In some aspects, action 320 may comprise the first BS 305a transmitting, to the second BS 305b via a RRC Transfer message, one or more UL SDT signals. The second BS 305b may then transmit, to the AFM 301 via a UL NAS Transport message, a UL NAS PDU including the UL SDT signal. In another aspect, action 320 may comprise the first BS 305a transmitting UL SDT data to the first BS 305a via a PUSCH communication, the first BS 305a forwarding the UL SDT data to the second BS 305b via a Xn communication, and the second BS 305b forwarding the UL SDT data to the UPF 303 via a NG-U communication.

At action 322, the second BS 305b receives, while the UE 315 remains in the inactive mode, DL non-SDT data and/or a DL non-SDT signal. In some aspects, the second BS 305b receives the DL non-SDT data and/or signal in a buffer of a radio bearer not enabled for SDT communications.

At action 324, the second BS 305b transmits, and the first BS 305a receives, a release message for the UE 315 to cause the UE 315 to suspend the RRC Resume procedure. In some aspects, action 324 comprises transmitting a RETRIEVE UE CONTEXT FAILURE message indicating that the full UE context will not be transferred to the first BS 305a. In some aspects, action 324 also comprises transmitted a RRCRelease message to the first BS 305a. The RRCRelease message may be ciphered based on a key associated with the second BS 305b. The message and/or messages transmitted at action 324 may also indicate the arrival of the DL non-SDT communication at the second BS 305b. The message or messages may be Xn messages. For example, in some aspects, the RETRIEVE UE CONTEXT FAILURE message may include at least one field for indicating whether non-SDT data is scheduled for transmission to the UE 315.

At action 326, the first BS 305a transmits, and the UE 315 receives, a random access message to cause the UE 315 to remain in the inactive mode or state such that the RRCResume procedure is suspended. For example, the random access message may comprise a RRCRelease message comprising a suspend config indication to cause the UE to remain in or return to the RRC_INACTIVE state. In some aspects, the RRCRelease message may be ciphered based on a key associated with the second BS 305b. In other aspects, the RRCRelease message may be ciphered based on a key associated with the first BS 305a.

At action 328, the UE 315 remains in or returns to the inactive mode. For example, action 328 may include the UE 315 remaining in the RRC_INACTIVE state.

At action 330, the first BS 305a transmits, and the UE 315 receives, a radio access network (RAN) paging message indicating the arrival of the DL non-SDT data and/or signaling. In some aspects, the paging message may cause the UE 315 to initiate a further random access procedure.

For example, receiving the paging message may cause the UE 315 to transmit a new RRCResume message to the first BS 305a. In some aspects, the method 300f may provide for an expedited re-initiation of a RACH procedure such that the UE 315 may transition to the connected mode in an expedited fashion for quicker receipt of the DL non-SDT data and/or signaling indicated to the UE 315 at action 326. In other words, due to the non-SDT indication in the paging message, the UE 315 may be made aware that the reason for the SDT termination was due to the arrival of the DL non-SDT communication. In some aspects, the UE 315 may adapt or modify its SDT procedures based on the indication of the arrival of the non-SDT data and/or signaling. For example, the UE 315 may, in the future, refrain from SDT protocols in favor of returning to the connected mode for SDT and/or non-SDT communications.

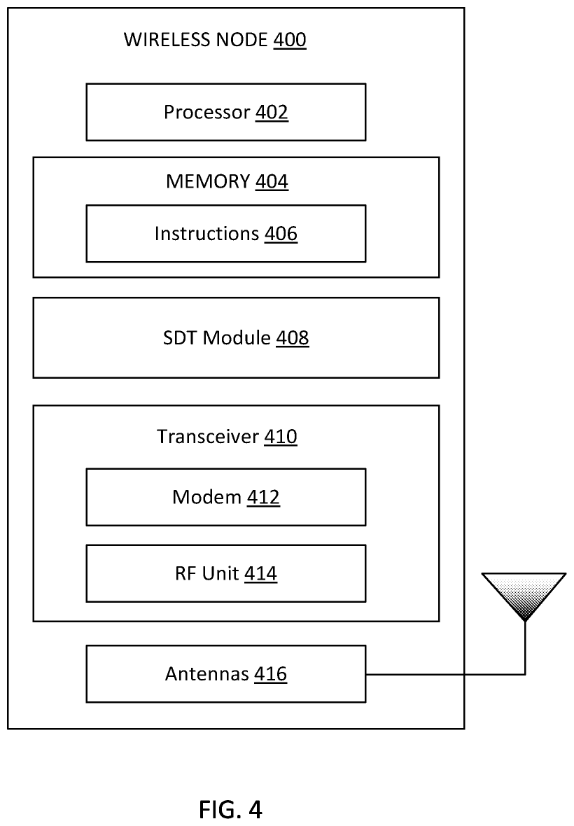

FIG. 4 is a block diagram of an exemplary UE 400 according to some aspects of the present disclosure. The UE 400 may be a UE 115 discussed above in FIG. 1A or a UE 315 discussed above in FIGS. 3A-3F. As shown, the UE 400 may include a processor 402, a memory 404, a SDT module 408, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 404 includes a non-transitory computer-readable medium. The memory 404 may store, or have recorded thereon, instructions 406. The instructions 406 may include instructions that, when executed by the processor 402, cause the processor 402 to perform the operations described herein with reference to the UEs 115 in connection with aspects of the present disclosure, for example, aspects of FIGS. 3A-3F, 6, 7, and/or 8. Instructions 406 may also be referred to as program code. The program code may be for causing a wireless communication device to perform these operations, for example by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The SDT module 408 may be implemented via hardware, software, or combinations thereof. For example, the SDT module 408 may be implemented as a processor, circuit, and/or instructions 406 stored in the memory 404 and executed by the processor 402. In some instances, the SDT module 408 can be integrated within the modem subsystem 412. For example, the SDT module 408 can be implemented by a combination of software components (e.g., executed by a DSP or a general processor) and hardware components (e.g., logic gates and circuitry) within the modem subsystem 412.

The SDT module 408 may be used for various aspects of the present disclosure, for example, aspects of aspects of FIGS. 3A-3F, 6, 7, and/or 8. The SDT module 408 is configured to communicate, or cause the transceiver 410 to communicate, SDT data and/or signaling with the network. In some aspects, the SDT module 408 may be configured to cause the transceiver 410 to transmit and/or receive random access messages for communicating SDT and/or non-SDT communications. For example, the SDT module 408 may be configured to cause the transceiver 410 to transmit RRCResumeRequest messages, UL SDT data, UL SDT signals, RRCResumeComplete messages, and/or any other suitable type of communication. In another aspect, the SDT module 408 may be configured to cause the transceiver 410 to receive, from one or more network nodes, random access communications, SDT communications, and/or non-SDT communications. For example, the SDT module 408 may be configured to cause the transceiver 410 to receive RRCResume messages, DL SDT data, DL SDT signals, DL non-SDT data, DL non-SDT signals, RRCRelease messages, and/or any other suitable type of communication. In some aspects, the SDT module 408 is configured to determine whether to communicate SDT data and/or signaling based on an indication of non-SDT data or signaling arrival at the network. For example, the SDT module 408 may update or modify a SDT protocol or configuration based on an indication that a SDT session failed based on the arrival of DL non-SDT data and/or signaling.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404 and/or the SDT module 408 according to a modulation and coding scheme (MCS), e.g., a low-density parity check (LDPC) coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., PUCCH control information, PRACH signals, PUSCH data, SDT data, non-SDT data, reference signals, RRC messages, etc.) from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 115 to enable the UE 115 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices. The antennas 416 may provide the received data messages for processing and/or demodulation at the transceiver 410. The transceiver 410 may provide the demodulated and decoded data (e.g., SSBs, PDCCH, PDSCH, RRC messages, SDT data, SDT signals, etc.) to the SDT module 408 for processing. The antennas 416 may include multiple antennas of similar or different designs in order to sustain multiple transmission links. The RF unit 414 may configure the antennas 416.

In an aspect, the UE 400 can include multiple transceivers 410 implementing different RATs (e.g., NR and LTE). In an aspect, the UE 400 can include a single transceiver 410 implementing multiple RATs (e.g., NR and LTE). In an aspect, the transceiver 410 can include various components, where different combinations of components can implement different RATs.

FIG. 5 is a block diagram of an exemplary network node 500 according to some aspects of the present disclosure. The network node 500 may be a BS 105 in the network 100 as discussed above in FIG. 1A or a network node 305 discussed above in FIGS. 3A-3F. A shown, the network node 500 may include a processor 502, a memory 504, a SDT module 508, a transceiver 510 including a modem subsystem 512 and a RF unit 514, and one or more antennas 516. These elements may be in direct or indirect communication with each other, for example via one or more buses. It will be understood that the network node 500 shown in FIG. 5 may be a BS and/or any other suitable type of network node or network unit. For example, the network node 500 may include an aggregated BS or a disaggregated BS, as described above with respect to FIG. 1AB.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 3A-3F, 6, 7, and/or 8. Instructions 506 may also be referred to as code, which may be interpreted broadly to include any type of computer-readable statement(s) as discussed above with respect to FIG. 4.

The SDT module 508 may be implemented via hardware, software, or combinations thereof. For example, the SDT module 508 may be implemented as a processor, circuit, and/or instructions 506 stored in the memory 504 and executed by the processor 502. In some instances, the SDT module 508 can be integrated within the modem subsystem 512. For example, the SDT module 508 can be implemented by a combination of software components (e.g., executed by a DSP or a general processor) and hardware components (e.g., logic gates and circuitry) within the modem subsystem 512.

The SDT module 508 may be used for various aspects of the present disclosure, for example, aspects of aspects of FIGS. 3A-3F, 6, 7, and/or 8. The SDT module 508 is configured to receive and/or transmit SDT communications, including SDT data and/or SDT signaling. The SDT module 508 may be configured to communicate, or cause the transceiver 510 to communicate, random access and/or connection management communications with a UE. For example, the SDT module 508 may be configured to receive RRCResumeRequest messages, UL SDT data, UL SDT signals, RRCResumeComplete messages, Retrieve UE context messages, UE context messages, Retrieve UE context failure messages, RRCRelease messages, and/or any other suitable type of message. The SDT module 508 may be configured to transmit, or cause the transceiver 510 to transmit, RRCResume messages, Retrieve UE context messages, Retrieve UE context failure messages, RRCRelease messages, UE context messages, DL SDT data, DL SDT signals, RAN paging messages, and/or any other suitable type of message. In some aspects, the SDT module 508 is configured to receive and/or provide for transmission an indication of an arrival of non-SDT data and/or signals for transmission to a UE. In some aspects, the SDT module 508 is configured to request and/or provide UE context based on the indication. In some aspects, the SDT module 508 is configured to communicate unciphered RRC messages with a request for a different network node to cipher.

As shown, the transceiver 510 may include the modem subsystem 512 and the RF unit 514. The transceiver 510 can be configured to communicate bi-directionally with other devices, such as the UEs 115 and/or 300 and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., SSBs, RMSI, MIB, SIB, FBE configuration, PRACH configuration PDCCH, PDSCH) from the modem subsystem 512 (on outbound transmissions) or of transmissions originating from another source such as a UE 115, the UE 315, and/or UE 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, e.g. data packets (or, more generally, data messages that may contain one or more data packets and other information), to the antennas 516 for transmission to one or more other devices. This may include, for example, transmission of information to complete attachment to a network and communication with a camped UE 115 or 215 according to some aspects of the present disclosure. The antennas 516 may further receive data messages transmitted from other devices and provide the received data messages for processing and/or demodulation at the transceiver 510. The transceiver 510 may provide the demodulated and decoded data (e.g., PUCCH control information, PRACH signals, PUSCH data) to the SDT module 508 for processing. The antennas 516 may include multiple antennas of similar or different designs in order to sustain multiple transmission links.

In an example, the transceiver 510 is configured to transmit, to a UE, system information including an FBE configuration indicating a plurality of frame periods, each including a gap period for contention at the beginning of the frame period, and communicate with the UE based on the FBE configuration, for example, by coordinating with the SDT module 508.

In an aspect, the network node 500 can include multiple transceivers 510 implementing different RATs (e.g., NR and LTE). In an aspect, the network node 500 can include a single transceiver 510 implementing multiple RATs (e.g., NR and LTE). In an aspect, the transceiver 510 can include various components, where different combinations of components can implement different RATs.

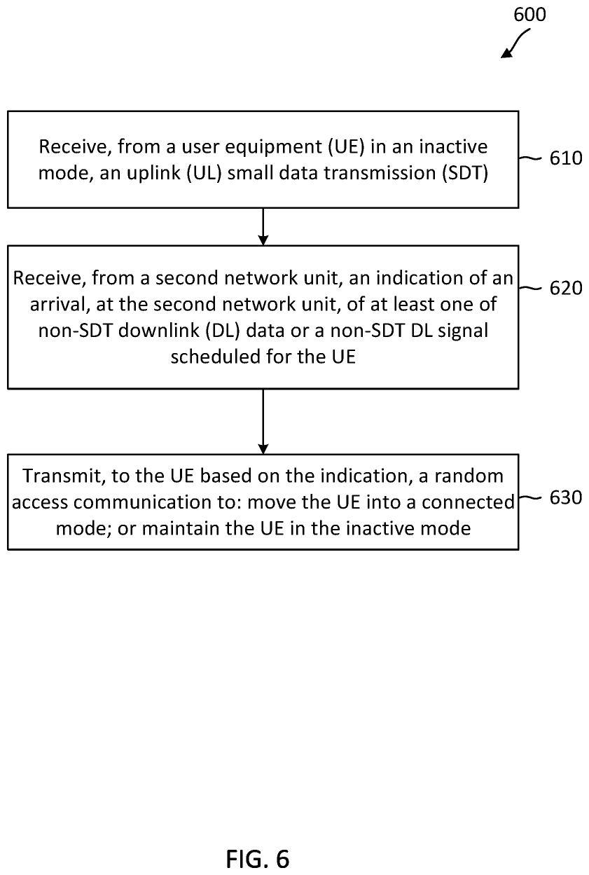

FIG. 6 is a flow diagram of a communication method 600 according to some aspects of the present disclosure. Steps of the method 600 can be executed by a computing device (e.g., a processor, processing circuit, and/or other suitable component) of an apparatus or other suitable means for performing the steps. For example, a network node, such as one of the BSs 105, the network nodes 305, and/or the network node 500, may utilize one or more components, such as the processor 502, the memory 504, the SDT module 508, the transceiver 510, and the one or more antennas 516, to execute the steps of method 600. The method 600 may employ similar mechanisms as in the methods 300a-300f described above with respect to FIGS. 3A-3F. As illustrated, the method 600 includes a number of enumerated steps, but aspects of the method 600 may include additional steps before, after, and in between the enumerated steps. In some aspects, one or more of the enumerated steps may be omitted or performed in a different order.

At block 610, a first network unit receives, from a UE in an inactive mode, a UL SDT. In some aspects, the UL SDT comprises UL SDT data. In other aspects, the UL SDT comprises a UL SDT signal. In some aspects, receiving the UL SDT may comprise receiving the UL SDT in a PUCCH, a PUSCH, and/or any other suitable UL physical channel. In some aspects, the first network unit may receive the UL SDT while the UE is in an RRC_INACTIVE mode or state. In some aspects, block 610 may comprise receiving, from the UE a RRC Resume Request message with the UL SDT.

At block 620, the first network unit receives, from a second network unit, an indication of an arrival, at the second network unit, of a non-SDT communication scheduled for transmission to the UE. The non-SDT communication may comprise DL data and/or DL signals. For example, the second network unit may receive DL data and/or signaling in a buffer of a radio bearer not enabled for SDT communications. In some aspects, the first network unit may be currently serving and configured to communicate with the UE. The second network unit may be a last-serving network unit and/or anchor network unit. The second network unit may retain the UE context. For example, the network may have performed a handover procedure to transfer the UE from a cell associated with the second network unit to a cell associated with the first network unit. However, the first network unit may not have the complete UE context for handling SDT and/or non-SDT communications.

At block 630, the first network unit transmits, to the UE based on the indication, a random access communication to: move the UE into a connected mode; or maintain the UE in the inactive mode. For example, in one aspect, block 630 comprises transmitting a RRCResume message to move the UE into a RRC_CONNECTED mode. In another aspect, block 630 comprises transmitting a RRCRelease message with a suspend config indication to maintain the UE in the inactive mode. In some aspects, the random access communication may indicate the arrival of the non-SDT communication at the second network unit. In some aspects, the random access communication may indicate resources for the UE to perform an additional random access or mobility procedure to move to the connected mode. For example, block 630 may comprise the second network unit transmitting, to the UE, an indication of one or more contention-free RACH (CFRA) resources for the UE to transmit at least one of a RRCResumeRequest message or a RACH preamble.

In some aspects, the method 600 further comprises transmitting, to the second network unit, a request for UE context relocation. For example, the first network unit may transmit a Xn message including the request for full UE context transfer. In another aspect, the method 600 may comprise receiving, from the second network unit, the UE context. In some aspects, the second network unit may transmit the UE context based on the request from the first network unit. In another aspect, the second network unit may transmit the UE context without a request and in response to the arrival of the non-SDT communication. In some aspects, the method 600 comprises determining, by the first network unit based on receiving the indication of the arrival of the non-SDT communication at the second network unit, whether to request for the full UE context relocation and whether to move the UE to the connected mode. In some aspects, the first network unit may request the UE context relocation and may transmit a RRC Resume message to the UE based on the determination.

In some aspects, the method 600 comprises transmitting, to the second network unit, a RRCResume message and a request to cipher the RRCResume message with the second network unit's key. In this regard, the first network unit may transmit, to the second network unit, an unciphered or pre-ciphered RRCResume message. The first network unit may then receive, from the second network unit, the RRCResume message ciphered with the second network unit's key. The first network unit may then transmit the ciphered RRCResume message to the UE over a Uu link. For example, the first network unit may transmit the ciphered RRCResume message in a PDSCH.

In some aspects, block 630 comprises transmitting a RRCRelease message to cause the UE to suspend the RRCResume procedure and remain in the inactive mode. In some aspects, the method 600 comprises receiving, from the second network unit via a Xn interface, the RRCRelease message ciphered with the second network unit's key, and forwarding the RRCRelease message to the UE over a Uu interface. In some aspects, the RRCRelease message may include or be associated with a Retrieve UE Context Failure message. In some aspects, the first network unit may transmit, with the RRCRelease message, and indication of the arrival of the non-SDT communication. In some aspects, the first network unit may also indicate CFRA resources for the UE to initiate a further random access or mobility procedure to move to the connected mode. In some aspects, the method 600 further comprises transmitting, to the UE, a RAN paging message while the UE is in the inactive mode, where the RAN paging message indicates the arrival of the non-SDT communication.

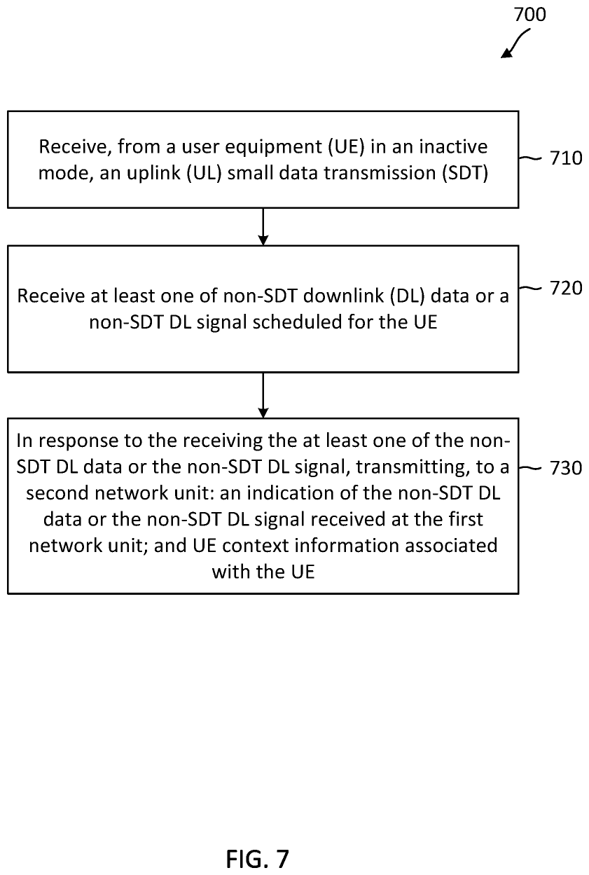

FIG. 7 is a flow diagram of a communication method 700 according to some aspects of the present disclosure. Steps of the method 700 can be executed by a computing device (e.g., a processor, processing circuit, and/or other suitable component) of an apparatus or other suitable means for performing the steps. For example, a network node, such as one of the BSs 105, the network nodes 305, and/or the network node 500, may utilize one or more components, such as the processor 502, the memory 504, the SDT module 508, the transceiver 510, and the one or more antennas 516, to execute the steps of method 700. The method 700 may employ similar mechanisms as in the methods 300a-300f described above with respect to FIGS. 3A-3F. As illustrated, the method 700 includes a number of enumerated steps, but aspects of the method 1000 may include additional steps before, after, and in between the enumerated steps. In some aspects, one or more of the enumerated steps may be omitted or performed in a different order.

At block 710, a first network unit receives, from a UE in an inactive mode, a UL SDT. In some aspects, the UL SDT comprises UL SDT data. In other aspects, the UL SDT comprises a UL SDT signal. In some aspects, receiving the UL SDT may comprise receiving the UL SDT via a second network unit in communication with the UE. In some aspects, the first network unit may receive the UL SDT from the second network unit that is currently serving the UE while the UE is in an RRC_INACTIVE mode or state. In some aspects, block 710 may comprise receiving a RRC Resume Request message with the UL SDT. In some aspects, the method 700 comprises the first network unit receiving, from the second network unit, a request to retrieve UE context including an indication of the UL SDT. In some aspects, the first network unit may determine to relocate only a portion of the UE context to the second network unit and to maintain at least a portion of the UE context. In some aspects, the first network unit may receive the UL SDT from the second network unit based on transmitting the partial UE context to the second network unit.

At block 720, the first network unit receives at least one of non-SDT DL data or a non-SDT DL signal scheduled for transmission to the UE. For example, the first network unit may receive DL data and/or signaling in a buffer of a radio bearer not enabled for SDT communications. In some aspects, the second network unit may be currently serving and configured to communicate with the UE. The first network unit may be a last-serving network unit and/or anchor network unit. The first network unit may retain the full UE context. For example, the network may have performed a handover procedure to transfer the UE from a cell associated with the first network unit to a cell associated with the second network unit.

At block 730, the first network unit transmits, to the second network unit and in response to the receiving the non-SDT DL data or the non-SDT DL signal, an indication of the arrival of the non-SDT DL data or the non-SDT DL signal. In some aspects, block 730 further comprises the first network unit transmitting, to the second network unit, UE context information associated with the UE.

In some aspects, the method 700 further comprises receiving, from the second network unit, a request for UE context relocation. For example, the first network unit may receive a Xn message including the request for full UE context transfer. In another aspect, the method 700 may comprise transmitting, to the second network unit, the UE context. In some aspects, the first network unit may transmit the UE context based on the request from the second network unit. In another aspect, the first network unit may transmit the UE context without a request and in response to the arrival of the non-SDT communication. In some aspects, the method 700 comprises determining, by the first network unit, whether to move the UE to the connected mode. In some aspects, the first network unit may transmit a RRC Resume message to the second network unit for transmission to the UE based on the determination.

In some aspects, the method 700 comprises receiving, from the second network unit, a RRCResume message and a request to cipher the RRCResume message with the first network unit's key. In this regard, the second network unit may transmit, to the first network unit, an unciphered or pre-ciphered RRCResume message. The first network unit may then transmit, to the second network unit, the RRCResume message ciphered with the second network unit's key. The second network unit may then transmit the ciphered RRCResume message to the UE over a Uu link.

In some aspects, the method 700 comprises transmitting a RRCRelease message to cause the UE to suspend the RRCResume procedure and remain in the inactive mode. In some aspects, the method 700 comprises transmitting, to the second network unit via a Xn interface, the RRCRelease message ciphered with the first network unit's key. In some aspects, the RRCRelease message may include or be associated with a Retrieve UE Context Failure message. In some aspects, the first network unit may transmit, with the RRCRelease message, and indication of the arrival of the non-SDT communication. In some aspects, the first network unit may also indicate CFRA resources for the UE to initiate a further random access or mobility procedure to move to the connected mode.

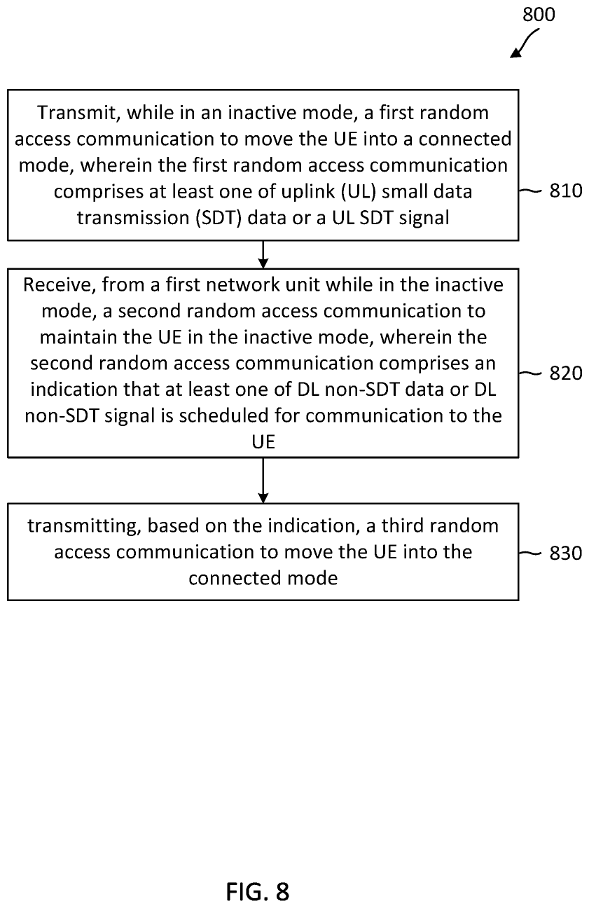

FIG. 8 is a flow diagram of a communication method 800 according to some aspects of the present disclosure. Steps of the method 800 can be executed by a computing device (e.g., a processor, processing circuit, and/or other suitable component) of an apparatus or other suitable means for performing the steps. For example, a UE, such as one of the UEs 115, the UE 315, and/or the UE 400, may utilize one or more components, such as the processor 402, the memory 404, the SDT module 408, the transceiver 410, and the one or more antennas 416, to execute the steps of method 800. The method 800 may employ similar mechanisms as in the methods 300a-300f described above with respect to FIGS. 3A-3F. As illustrated, the method 800 includes a number of enumerated steps, but aspects of the method 800 may include additional steps before, after, and in between the enumerated steps. In some aspects, one or more of the enumerated steps may be omitted or performed in a different order.

At block 810, the UE transmits, while in an inactive mode, a first random access communication to move the UE into a connected mode. The random access communication may also include a UL SDT. In some aspects, the UL SDT comprises UL SDT data. In other aspects, the UL SDT comprises a UL SDT signal. In some aspects, receiving the UL SDT may comprise receiving the UL SDT in a PUCCH, a PUSCH, and/or any other suitable UL physical channel. In some aspects, the UE may transmit the random access communication and UL SDT while the UE is in an RRC_INACTIVE mode or state. In some aspects, block 810 may comprise transmitting, to a network unit, a RRC Resume Request message with the UL SDT.

At block 820, the UE receives, from a first network unit while the UE is in the inactive mode, a second random access communication to maintain the UE in the inactive mode. In some aspects, the second random access communication may comprise a RRC Release message. The RRC Release message may include a suspend config indication. In some aspects, the second random access communication further comprises an indication of an arrival, at a second network unit, of a non-SDT communication scheduled for transmission to the UE. The non-SDT communication may comprise DL data and/or DL signals. For example, the second network unit may receive DL data and/or signaling in a buffer of a radio bearer not enabled for SDT communications. In some aspects, the first network unit may be currently serving and configured to communicate with the UE. The second network unit may be a last-serving network unit and/or anchor network unit. The second network unit may retain the UE context. For example, the network may have performed a handover procedure to transfer the UE from a cell associated with the second network unit to a cell associated with the first network unit. However, the first network unit may not have the complete UE context for handling SDT and/or non-SDT communications.

At block 830, the UE transmits, based on the indication, a third random access communication to move the UE into a connected mode. For example, the third random access communication may comprise a second RRC Resume Request message to move to the connected mode. In some aspects, the transmitting the RRC Resume Request message may be performed based on CFRA resources indicated in the second random access message. In another aspect, block 830 comprises transmitting a RRCRelease message with a suspend config indication to maintain the UE in the inactive mode. In some aspects, the random access communication may indicate the arrival of the non-SDT communication at the second network unit. In some aspects, the random access communication may indicate resources for the UE to perform an additional random access or mobility procedure to move to the connected mode. For example, block 830 may comprise the second network unit transmitting, to the UE, an indication of one or more contention-free RACH (CFRA) resources for the UE to transmit at least one of a RRCResumeRequest message or a RACH preamble.

### EXEMPLARY ASPECTS OF THE DISCLOSURE

Aspect 1. A method of wireless communication performed by a first network unit, the method comprising: receiving, from a user equipment (UE) in an inactive mode, an uplink (UL) small data transmission (SDT); receiving, from a second network unit, an indication of an arrival, at the second network unit, of at least one of non-SDT downlink (DL) data or a non-SDT DL signal scheduled for the UE; and transmitting, to the UE based on the indication, a random access communication to: move the UE into a connected mode; or maintain the UE in the inactive mode.
Aspect 2. The method of aspect 1, wherein the transmitting the random access communication comprises transmitting a radio resource control (RRC) resume message to move the UE into the connected mode.
Aspect 3. The method of aspect 2, further comprising: receiving, from the second network unit, UE context information associated with the UE.
Aspect 4. The method of aspect 3, wherein: the receiving the UE context information comprises receiving a UE context request response; and the UE context request response includes the indication of the at least one of the non-SDT DL data or the non-SDT DL signal.
Aspect 5. The method of any of aspects 3-4, further comprising: transmitting, to the second network unit in response to receiving the indication, a request for the UE context information.
Aspect 6. The method of aspect 5, wherein: the transmitting the request for the UE context information comprises transmitting a pre-ciphered RRC resume message to the second network unit; and the method further comprises: receiving, from the second network unit, the RRC resume message, wherein the RRC resume message is ciphered based on a key associated with the second network unit; and the transmitting the RRC resume message comprises transmitting the RRC resume message ciphered based on the key associated with the second network unit.
Aspect 7. The method of any of aspects 1-6, wherein the transmitting the random access communication comprises transmitting a radio resource control (RRC) release message to maintain the UE in the inactive mode.
Aspect 8. The method of aspect 7, wherein the RRC release message indicates the arrival of the non-SDT DL data or the non-SDT DL signal.
Aspect 9. The method of any of aspects 7-8, wherein the receiving the indication comprises: receiving, from the second network unit, the RRC release message, wherein the RRC release message indicates: a UE context relocation failure; and the arrival of the non-SDT DL data or the non-SDT DL signal.
Aspect 10. The method of aspect 9, wherein: the RRC release message indicates random access resources, and the method further comprises: receiving, from the UE based on the random access resources, a random access preamble.
Aspect 11. The method of any of aspects 7-10, further comprising: transmitting, to the UE after the transmitting the RRC release message, a paging message indicating the arrival of the non-SDT DL data or the non-SDT DL signal.
Aspect 12. A method of wireless communication performed by a first network unit, the method comprising: receiving, from a user equipment (UE) in an inactive mode, an uplink (UL) small data transmission (SDT); receiving at least one of non-SDT downlink (DL) data or a non-SDT DL signal scheduled for the UE; and in response to the receiving the at least one of the non-SDT DL data or the non-SDT DL signal, transmitting, to a second network unit: an indication of the non-SDT DL data or the non-SDT DL signal received at the first network unit; and UE context information associated with the UE.
Aspect 13. The method of aspect 12, wherein: the transmitting the UE context information comprises transmitting a UE context request response; and the UE context request response includes the indication of the at least one of the non-SDT DL data or the non-SDT DL signal.
Aspect 14. The method of any of aspects 12-13, further comprising: receiving, from the second network unit, a request for the UE context information, wherein the transmitting the UE context information is based on the request for the UE context information.
Aspect 15. The method of aspect 14, wherein: the receiving the request for the UE context information comprises receiving, from the second network unit, a pre-ciphered radio resource control (RRC) resume message, the pre-ciphered RRC resume message indicates the request for the UE context information; and the method further comprises: transmitting, to the second network unit, the RRC resume message ciphered with a key associated with the first network unit.
Aspect 16. The method of any of aspects 12-16, wherein the transmitting the indication comprises transmitting a radio resource control (RRC) release message to move the UE into the inactive mode, wherein the RRC release message includes the indication.
Aspect 17. The method of aspect 16, wherein the RRC release message further indicates a UE context relocation failure.
Aspect 18. The method of aspect 17, wherein: the RRC release message further indicates random access resources for the UE to transmit a random access preamble.
Aspect 19. A method of wireless communication performed by a user equipment (UE), the method comprising: transmitting, while in an inactive mode, a first random access communication to move the UE into a connected mode, wherein the first random access communication comprises at least one of uplink (UL) small data transmission (SDT) data or a UL SDT signal; receive, from a first network unit while in the inactive mode, a second random access communication to maintain the UE in the inactive mode, wherein the second random access communication comprises an indication that at least one of DL non-SDT data or DL non-SDT signal is scheduled for communication to the UE; and transmitting, based on the indication, a third random access communication to move the UE into the connected mode.
Aspect 20. The method of aspect 19, wherein: the second random access communication indicates random access resources; and the transmitting the third random access communication comprises transmitting, based on the indication, the third random access communication in at least a portion of the random access resources.
Aspect 21. A first network unit, comprising: a memory device; a transceiver; and a processor in communication with the memory device and the transceiver, wherein the first network unit is configured to perform the actions of any of aspects 1-11.
Aspect 22. A first network unit, comprising: a memory device; a transceiver; and a processor in communication with the memory device and the transceiver, wherein the first network unit is configured to perform the steps of any of aspects 12-18.
Aspect 23. A UE, comprising: a memory device; a transceiver; and a processor in communication with the memory device and the transceiver, wherein the UE is configured to perform the steps of any of aspects 19-20.
Aspect 24. A non-transitory, computer-readable medium having program code recorded thereon, wherein the program code comprises instructions executable by a processor of a first network unit to cause the first network unit to perform the steps of any of aspects 1-11.
Aspect 25. A non-transitory, computer-readable medium having program code recorded thereon, wherein the program code comprises instructions executable by a processor of a first network unit to cause the first network unit to perform the steps of any of aspects 12-18.
Aspect 26. A non-transitory, computer-readable medium having program code recorded thereon, wherein the program code comprises instructions executable by a processor of a first network unit to cause the first network unit to perform the steps of any of aspects 19-20.
Aspect 27. A first network unit comprising means for performing the steps of any of aspects 1-11.
Aspect 28. A first network unit comprising means for performing the steps of any of aspects 12-18.
Aspect 29. A UE comprising means for performing the steps of any of aspects 19-20.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A method of wireless communication performed by a first network unit, the method comprising:
receiving, from a user equipment (UE) in an inactive mode, an uplink (UL) small data transmission (SDT);
receiving, from a second network unit, an indication of an arrival, at the second network unit, of at least one of non-SDT downlink (DL) data or a non-SDT DL signal scheduled for the UE; and
transmitting, to the UE based on the indication, a random access communication to:
move the UE into a connected mode; or
maintain the UE in the inactive mode.

2. The method of claim 1, wherein the transmitting the random access communication comprises transmitting a radio resource control (RRC) resume message to move the UE into the connected mode.

3. The method of claim 2, further comprising:
receiving, from the second network unit, UE context information associated with the UE.

4. The method of claim 3, wherein:
the receiving the UE context information comprises receiving a UE context request response; and
the UE context request response includes the indication of the at least one of the non-SDT DL data or the non-SDT DL signal.

5. The method of claim 3, further comprising:
transmitting, to the second network unit in response to receiving the indication, a request for the UE context information.

6. The method of claim 5, wherein:
the transmitting the request for the UE context information comprises transmitting a pre-ciphered RRC resume message to the second network unit; and
the method further comprises:
receiving, from the second network unit, the RRC resume message, wherein the RRC resume message is ciphered based on a key associated with the second network unit; and
the transmitting the RRC resume message comprises transmitting the RRC resume message ciphered based on the key associated with the second network unit.

7. The method of claim 1, wherein the transmitting the random access communication comprises transmitting a radio resource control (RRC) release message to maintain the UE in the inactive mode.

8. The method of claim 7, wherein the RRC release message indicates the arrival of the non-SDT DL data or the non-SDT DL signal.

9. The method of claim 7, wherein the receiving the indication comprises:
receiving, from the second network unit, the RRC release message, wherein the RRC release message indicates:
a UE context relocation failure; and
the arrival of the non-SDT DL data or the non-SDT DL signal.

10. The method of claim 9, wherein:
the RRC release message indicates random access resources, and
the method further comprises:
receiving, from the UE based on the random access resources, a random access preamble.

11. The method of claim 7, further comprising:
transmitting, to the UE after the transmitting the RRC release message, a paging message indicating the arrival of the non-SDT DL data or the non-SDT DL signal.

12. A method of wireless communication performed by a first network unit, the method comprising:
receiving, from a user equipment (UE) in an inactive mode, an uplink (UL) small data transmission (SDT);
receiving at least one of non-SDT downlink (DL) data or a non-SDT DL signal scheduled for the UE; and
in response to the receiving the at least one of the non-SDT DL data or the non-SDT DL signal, transmitting, to a second network unit:
an indication of the non-SDT DL data or the non-SDT DL signal received at the first network unit; and
UE context information associated with the UE.

13. The method of claim 12, wherein:
the transmitting the UE context information comprises transmitting a UE context request response; and
the UE context request response includes the indication of the at least one of the non-SDT DL data or the non-SDT DL signal.

14. The method of claim 12, further comprising:
receiving, from the second network unit, a request for the UE context information,
wherein the transmitting the UE context information is based on the request for the UE context information.

15. The method of claim 14, wherein:
the receiving the request for the UE context information comprises receiving, from the second network unit, a pre-ciphered radio resource control (RRC) resume message,
the pre-ciphered RRC resume message indicates the request for the UE context information; and
the method further comprises:
transmitting, to the second network unit, the RRC resume message ciphered with a key associated with the first network unit.

16. The method of claim 12, wherein the transmitting the indication comprises transmitting a radio resource control (RRC) release message to move the UE into the inactive mode, wherein the RRC release message includes the indication.

17. The method of claim 16, wherein the RRC release message further indicates a UE context relocation failure.

18. (canceled)

19. A method of wireless communication performed by a user equipment (UE), the method comprising:
transmitting, while in an inactive mode, a first random access communication to move the UE into a connected mode, wherein the first random access communication comprises at least one of uplink (UL) small data transmission (SDT) data or a UL SDT signal;
receive, from a first network unit while in the inactive mode, a second random access communication to maintain the UE in the inactive mode, wherein the second random access communication comprises an indication that at least one of DL non-SDT data or DL non-SDT signal is scheduled for communication to the UE; and
transmitting, based on the indication, a third random access communication to move the UE into the connected mode.

20. The method of claim 19, wherein:
the second random access communication indicates random access resources; and
the transmitting the third random access communication comprises transmitting, based on the indication, the third random access communication in at least a portion of the random access resources.

21. A first network unit, comprising:
a memory device;
a transceiver; and
a processor in communication with the memory device and the transceiver, wherein the first network unit is configured to:
receive, from a user equipment (UE) in an inactive mode, an uplink (UL) small data transmission (SDT);
receive, from a second network unit, an indication of an arrival, at the second network unit, of at least one of non-SDT downlink (DL) data or a non-SDT DL signal scheduled for the UE; and
transmit, to the UE based on the indication, a random access communication to:
move the UE into a connected mode; or
maintain the UE in the inactive mode.

22-30. (canceled)
